(19) United States
(12) Patent Application Publication
(10) Pub. No.: US 2018/0039146 A1
(43) Pub. Date: Feb. 8, 2018

(54) ACTIVE MATRIX SUBSTRATE, AND DISPLAY DEVICE INCLUDING SAME

(71) Applicant: Sharp Kabushiki Kaisha, Sakai City, Osaka (JP)

(72) Inventors: Kohhei TANAKA, Sakai City (JP); Takeshi NOMA, Sakai City (JP); Takayuki NISHIYAMA, Sakai City (JP); Ryo YONEBAYASHI, Sakai City (JP)

(21) Appl. No.: 15/555,118

(22) PCT Filed: Mar. 2, 2016
(86) PCT No.: PCT/JP2016/056476

§ 371 Date: Sep. 1, 2017

(30) Foreign Application Priority Data
Mar. 2, 2015 (JP) 2015-040127

(51) Int. Cl. G02F 1/1362; G02F 1/1345; G09G 3/36; G02F 1/1335

(52) U.S. Cl. CPC G02F 1/136286; G02F 1/133514; G02F 1/13452; G09G 3/3648; G02F 1/1368

(57) ABSTRACT

Provided is an active matrix substrate having a narrower frame region, the active matrix substrate having a display region in which a plurality of pixel regions that have pixel groups independent from one another, respectively, are arrayed along the gate lines. An active matrix substrate 20a has a display region 200 in which a pixel region 201A and a pixel region 201B that include gate lines and source lines, respectively, are arrayed along a direction in which the gate lines extend. In the pixel region 201A and the pixel region 201B, gate drivers 11 for driving gate lines 13 in the pixel regions are provided. In a frame region R1, a terminal part 12s for supplying data signals to the data lines are provided. One-side ends of data lines 15a in the pixel region 201A are routed from the terminal part 12s, and the data lines 15b in the pixel region 201A are connected with the data lines 15a in the pixel region 201A.

### TECHNICAL FIELD

The present invention relates to an active matrix substrate and a display device including the same.

### BACKGROUND ART

Patent Document 1 described below discloses a display panel in which two pixel regions each of which includes a group of pixels defined by a plurality of gate lines and a plurality of data lines are arrayed in a direction in which the gate lines extend. The data lines in each pixel region are connected to one another in a frame region in the vicinity of one-side ends of the data lines. Further, in frame regions on the right and left sides of the display panel, gate drivers for the respective pixel regions are arranged.

### PRIOR ART DOCUMENT

### Patent Document

Patent Document 1: U.S. Pat. No. 8,659,583

### SUMMARY OF THE INVENTION

### Problem to be Solved by the Invention

In a case of a display panel in which a plurality of pixel regions are arrayed along the gate lines, if driving circuits for driving gate lines in each pixel region are arranged in frame regions on the right and left sides of the display panel as is the case with Patent Document 1, the frame regions on the right and left sides of the display panel cannot be narrowed.

It is an object of the present invention to provide a technique for narrowing a frame region in an active matrix substrate that includes a display region in which a plurality of pixel regions are arrayed along gate lines, the pixel regions including pixel groups independent from each other, respectively.

### Means to Solve the Problem

An active matrix substrate according to the present invention includes: a display region in which a plurality of pixel regions each of which includes data lines and gate lines are arrayed along a direction in which the gate lines extend; a terminal part provided outside the display region, in a first frame region in vicinity of one-side ends of the data lines, the terminal part supplying a data signal; and driving circuits provided in each of the pixel regions, for switching the gate lines in the pixel regions to a selected state or a non-selected state. In the active matrix substrate, the data lines in at least one pixel region among the plurality of pixel regions are connected with the terminal part, and the data lines in another pixel region are connected with the data lines in the one pixel region.

### Effect of the Invention

With the configuration of the present invention, it is possible to narrow a frame region in an active matrix substrate that includes a display region in which a plurality of pixel regions are arrayed along gate lines, the pixel regions including pixel groups independent from each other, respectively.

### BRIEF DESCRIPTION OF DRAWINGS

FIG. 1 illustrates a schematic configuration of a liquid crystal display device according to Embodiment 1.

FIG. 2 is a schematic diagram illustrating an exemplary arrangement of source lines on the active matrix substrate illustrated in FIG. 1.

FIG. 3 is a schematic diagram illustrating a schematic configuration of the active matrix substrate in which the illustration of the source lines shown in FIG. 2 is omitted.

FIG. 4 illustrates an equivalent circuit of the gate driver illustrated in FIG. 3.

FIG. 5A is a schematic diagram illustrating an arrangement layout of the gate drivers illustrated in FIG. 4.

FIG. 5B is a schematic diagram illustrating an arrangement layout of the gate drivers illustrated in FIG. 4.

FIG. 6 illustrates a timing chart when the gate driver illustrated in FIG. 4 drives the gate lines.

FIG. 7 illustrates a timing chart of a data signal writing operation in Embodiment 1.

FIG. 8 illustrates a comparative example for the an active matrix substrate in Embodiment 1.

FIG. 9 is a schematic diagram illustrating an exemplary arrangement of source lines in an active matrix substrate in Embodiment 2.

FIG. 10A is an enlarged schematic diagram illustrating a connection part in the frame region illustrated in FIG. 9 where the source line portions and the source lines are connected.

FIG. 10B is a cross-sectional view taken along line I-I in FIG. 10 A, at the connection part where the source line and the routing line portion are connected with a connection line.

FIG. 11 illustrates a timing chart of a data signal writing operation in Embodiment 2.

FIG. 12 is a schematic diagram illustrating an exemplary arrangement of source lines in an active matrix substrate in Embodiment 3.

FIG. 13 illustrates a timing chart of a data signal writing operation in Embodiment 3.

FIG. 14 is a schematic diagram illustrating exemplary connection of source lines on an active matrix substrate in Embodiment 4.

FIG. 15 illustrates a timing chart of a data signal writing operation in Embodiment 4.

FIG. 16A is an enlarged schematic diagram of source lines in a broken line frame P illustrated in FIG. 14.

FIG. 16B is a cross-sectional view illustrating the source lines illustrated in FIG. 16A, taken along line II-II.

FIG. 16C is a cross-sectional view illustrating the source lines illustrated in FIG. 16A, taken along line II-II.

FIG. 17A is an enlarged schematic diagram illustrating a connection part in the frame region where the source line portions and the source lines are connected in Embodiment 5.

FIG. 17B is a cross-sectional view of the connection part illustrated in FIG. 17A, taken along line III-III.

FIG. 18 is a schematic diagram illustrating an active matrix substrate in Embodiment 6.

FIG. 19 illustrates a timing chart of a data signal writing operation in Embodiment 6.

FIG. 20 is a schematic diagram illustrating a schematic configuration of an active matrix substrate in Embodiment 7.

FIG. 21 illustrates an equivalent circuit of the gate driver illustrated in Embodiment 7.

FIG. 22A is a schematic diagram illustrating an arrangement layout of the gate drivers illustrated in FIG. 21.

FIG. 22B is a schematic diagram illustrating an arrangement layout of the gate drivers illustrated in FIG. 21.

FIG. 22C is a schematic diagram illustrating an arrangement layout of the gate drivers illustrated in FIG. 21.

FIG. 22D is a schematic diagram illustrating an arrangement layout of the gate drivers illustrated in FIG. 21.

FIG. 22E is a schematic diagram illustrating an arrangement layout of the gate drivers illustrated in FIG. 21.

FIG. 23 illustrates a timing chart when the gate driver illustrated in FIG. 21 drives a part of the gate lines.

FIG. 24A is a timing chart of a data signal writing operation with respect to the first frame in Embodiment 7.

FIG. 24B is a timing chart of a data signal writing operation in each frame period with respect to the second to sixtieth frames in Embodiment 7.

FIG. 25 is a schematic configuration of an active matrix substrate in Embodiment 8.

FIG. 26 is a schematic diagram illustrating an exemplary connection of source lines on an active matrix substrate in a modification example (1).

### MODE FOR CARRYING OUT THE INVENTION

An active matrix substrate according to one embodiment of the present invention includes: a display region in which a plurality of pixel regions each of which includes data lines and gate lines are arrayed along a direction in which the gate lines extend; a terminal part provided outside the display region, in a first frame region in vicinity of one-side ends of the data lines, the terminal part supplying a data signal; and driving circuits provided in each of the pixel regions, for switching the gate lines in the pixel regions to a selected state or a non-selected state. In the active matrix substrate, the data lines in at least one pixel region among the plurality of pixel regions are connected with the terminal part, and the data lines in another pixel region are connected with the data lines in the one pixel region (the first configuration).

According to the first configuration, the active matrix substrate includes a display region in which a plurality of pixel regions are arrayed along a direction in which the gate lines extend. The active matrix substrate includes a terminal part in a first frame region for supplying a data signal to the data lines. Further, the active matrix substrate includes driving circuits provided in each of the pixel regions, for switching the gate lines in the pixel regions to a selected state or a non-selected state. The data lines in at least one pixel region are connected with the terminal part, and the data lines in another pixel region are connected with the data lines in the one pixel region.

In the first configuration, driving circuits are provided in each pixel region, which narrow the frame region in the vicinity of ends of the gate lines. Further, as the driving circuits are provided in each pixel region, a display region in which three or more pixel regions are arrayed along the gate line extending direction can be formed on the active matrix substrate. Further, the number of data lines connected with the terminal part is smaller than the total number of the data lines in all of the pixel regions. In other words, the number of data lines routed from the terminal part to the first frame region can be reduced, which makes it possible to narrow the first frame region, as compared with a case where all of the data lines are routed from the terminal part to the first frame region.

The second configuration may be the first configuration further characterized as follows: the data lines in the one pixel region and the data lines in the another pixel region are connected with each other in the first frame region.

With the second configuration, the data lines in the one pixel region can be connected with the data lines in the another pixel region in the first frame region. This makes it possible to narrow the first frame region, as compared with a case where all of the data lines are connected with the terminal part.

The third configuration may be the second configuration that further includes a switching part that selectively switches the data lines in the one pixel region for inputting the data signal, among the data lines in the one pixel region and the another pixel region.

With the third configuration, the data lines in the one pixel region for inputting a data signal can be selectively switched, whereby the electric power consumption when data signals are input can be reduced.

The fourth configuration may be the second or third configuration further characterized as follows: the active matrix substrate has a laminate structure that includes a first metal layer, and a second metal layer that is different from the first metal layer; the gate lines are formed in the first metal layer; the data lines are formed in the second metal layer; and the active matrix substrate further includes connection lines formed in the first metal layer or the second metal layer, the connection lines connecting, among the data lines of the another pixel region, the data lines that when extended intersect with the data lines of the one pixel region in the first frame region, and the data lines of the one pixel region.

With the fourth configuration, the data lines in the one pixel region and the data lines in the another pixel region can be connected, without intersecting with each other, by the connection lines.

The fifth configuration may be the second or third configuration further characterized as follows: the active matrix substrate has a laminate structure that includes a first metal layer, and a second metal layer that is different from the first metal layer; the gate lines are formed in the first metal layer; the data lines in the another pixel region are formed in the second metal layer; the data lines in the one pixel region have portions arranged in the one pixel region, which are formed in the second metal layer, and portions arranged in the first frame region, which are formed in the first metal layer; and the active matrix substrate further includes connection lines formed in the second metal layer, the connection lines connecting the data lines in the another pixel region and the data lines in the one pixel region.

With the fifth configuration, the data lines in the one pixel region and the data lines in the another pixel region can be connected, without intersecting with each other, by the connection lines.

The sixth configuration may be the second configuration further characterized as follows: the active matrix substrate has a laminate structure that includes a first metal layer, a second metal layer that is different from the first metal layer, and a third metal layer that is different from the first and second metal layers; the gate lines are formed in the first metal layer; the data lines in the another pixel region are formed in the second metal layer; the data lines in the one pixel region have portions arranged in the one pixel region, which are formed in the second metal layer, and portions arranged in the first frame region, which are formed in the first metal layer or the second metal layer; and the active matrix substrate further includes connection lines formed in the third metal layer, the connection lines connecting the data lines in the one pixel region and the data lines in the another pixel region.

With the sixth configuration, the data lines in the one pixel region and the data lines in the another pixel region can be connected, without intersecting with each other, by the connection lines. Besides, since portions of the data lines in the another pixel region arranged in the first frame region are formed in one of the first metal layer and the second metal layer, the interval of the data lines arranged in the first frame region can be narrowed, as compared with a case where the data lines are formed in the same metal layer. As a result, the first frame region can be further narrowed.

The seventh configuration may be the first configuration further characterized as follows: the data lines in the another pixel region are formed with the data lines in the one pixel region that are extended to the another pixel region while passing through a second frame region that is on an opposite side to the first frame region.

According to the seventh configuration, the data lines in the one pixel region double as the data lines in the another pixel region. Only the same number of data lines as in the one pixel region are therefore required to be arranged in the first frame region, which makes it possible to narrow the first frame region.

The eighth configuration may be the first configuration further characterized in that the data lines of the one pixel region and the data lines of the another pixel region are connected with each other in the display region.

According to the eighth configuration, the data lines of the one pixel region are connected with the data lines of the another pixel region in the display region. This makes it possible to narrow the first frame region, as compared with a case where all of the data lines are connected with the terminal part.

The ninth configuration may be any one of the first to seventh configurations further characterized in that a frame frequency for writing the data signal to a part of pixels in at least one pixel region among the pixel regions is lower than a frame frequency for writing the data signal to other pixels in the pixel region.

With the ninth configuration, it is possible to cause a part of pixels to display a still image, and cause other pixels to display a moving image, thereby reducing the electric power consumption when data signals are written.

The tenth configuration may be any one of the first to ninth configuration further characterized in that the display region has a non-rectangular shape.

A display device according to one embodiment of the present invention includes the active matrix substrate having any one of the first to tenth configurations, and a counter substrate including color filters provided at positions respectively corresponding to the pixels on the active matrix substrate (the eleventh configuration).

The twelfth configuration may be the eleventh configuration further characterized in that the color filters include color filters of R (red), G (green), and B (blue), and the color filters of R (red), G (green), and B (blue) are arrayed in an order of R (red), G (green), and B (blue) along a direction in which the data lines extend on the active matrix substrate.

With the twelfth configuration, the number of data lines can be decreased, as compared with a case where the pixels corresponding to the color filters of R (red), G (green), and B (blue) are arrayed in an order of R (red), G (green), and B (blue) along a direction in which the gate lines extend. As a result, the number of data lines routed from the terminal part to the first frame region can be reduced, whereby the first frame region can be further narrowed.

The following describes embodiments of the present invention in detail, while referring to the drawings. Identical or equivalent parts in the drawings are denoted by the same reference numerals, and the descriptions of the same are not repeated.

### Embodiment 1

### (Configuration of Liquid Crystal Display Device)

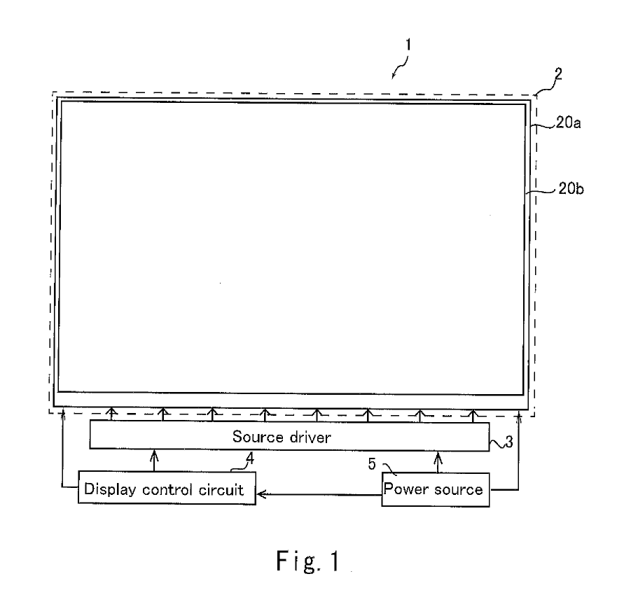

FIG. 1 is a top view illustrating a schematic configuration of a liquid crystal display device according to the present embodiment. The liquid crystal display device 1 includes a display panel 2, a source driver 3, a display control circuit 4, and a power source 5. The display panel 2 includes an active matrix substrate 20a, a counter substrate 20b, and a liquid crystal layer (not shown) interposed between these substrates. Though the illustration is omitted in FIG. 1, a pair of polarizing plates are provided so that the active matrix substrate 20a and the counter substrate 20b are interposed therebetween. On the counter substrate 20b, there are formed a black matrix (BM), color filters of three colors, which are red (R), green (G), and blue (B), and a common electrode (all are not shown).

As illustrated in FIG. 1, the active matrix substrate 20a is electrically connected with the source driver 3 formed on a flexible substrate. The display control circuit 4 is electrically connected with the display panel 2, the source driver 3, and the power source 5. The display control circuit 4 outputs control signals to the source driver 3, and driving circuits (referred to as gate drivers) provided on the active matrix substrate 20a, which are described below. The power source 5 is electrically connected with the display panel 2, the source driver 3, and the display control circuit 4, and supplies a power source voltage signal to each of the same.

### (Configuration of Active Matrix Substrate)

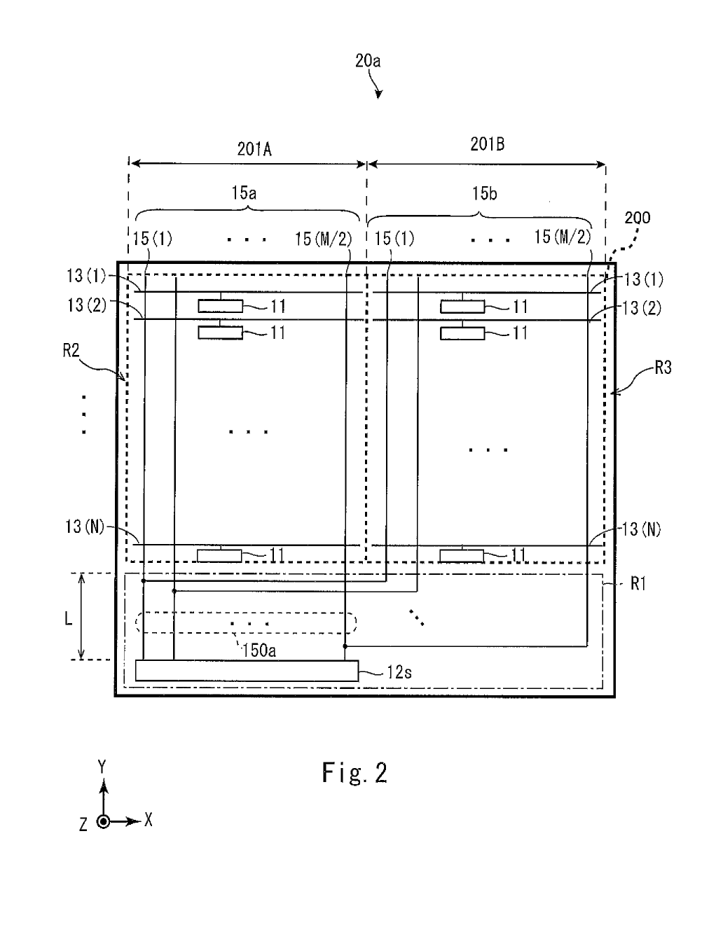

FIG. 2 is a schematic diagram illustrating a schematic configuration of the active matrix substrate 20a. The active matrix substrate 20a includes a display region 200 in a rectangular shape in which areas 201A and 201B that include independent pixel groups, respectively, are arrayed along an X axis direction.

N gate lines 13 (13(1) to 13(N)) are formed in each of the area 201A and the area 201B, and are driven independently by areas.

In the area 201A, M/2 (M: even integer) source lines (data lines) 15a (15(1) to 15(M/2) are formed. Each data line 15a in the area 201A has the following configuration: one-side ends thereof is connected with a terminal part 12s, and is extended from the terminal part 12s, in a direction approximately vertical to the gate lines 13, over a frame region R1 outside the display region 200, on one of sides parallel to the gate lines 13, and the area 201A.

In the area 201B, M/2 source lines 15b (15(1) to 15(M/2) are formed. Each data line 15b in the area 201B has the following configuration: one-side end thereof is connected with the source line 15a of the area 201A, at the frame region R1, is extended from the connection position in a direction approximately parallel with the gate lines 13 to a predetermined position in the frame region R1, and is extended from the predetermined position in the direction approximately vertical to the gate lines 13 in the area 201B. Hereinafter the source lines in the area 201A and those in the area 201B are referred to as the source lines 15 when they are not distinguished from each other.

In other words, in this example, M source lines 15 in total are provided in the areas 201A and 201B in the active matrix substrate 20a.

Further, in the active matrix substrate 20a, the terminal part 12s is provided in the frame region R1. The terminal part 12s receives data signals supplied from the source driver 3.

In the present embodiment, the source lines 15a in one area 201A are connected to the terminal part 12s, and the source lines 15b in the other area 201B are connected, in the frame region R1, with the source lines 15a of the area 201A. The number of the source lines 15 routed from the terminal part 12s to the frame region R1 is therefore only M/2. The width L in the extending direction of the source line 15 in the frame region R1 is required only to have a length for arranging the M/2 source lines 15 of the area 201B in parallel.

In this example, the source lines 15a of the area 201A are connected with the terminal part 12s, but the configuration may such that the source lines 15b of the area 201B and the terminal part 12s are connected, and the source lines 15a of the area 201A are connected, in the frame region R1, with the source lines 15b of the area 201B.

Each pixel in the areas 201A and 201B corresponds to any one of the colors of R, G, and B of the color filters. The color filters of the respective colors of R, G, and B in the counter substrate 20b are arrayed in the order of R, G, and B along the direction in which the gate lines 13 extend.

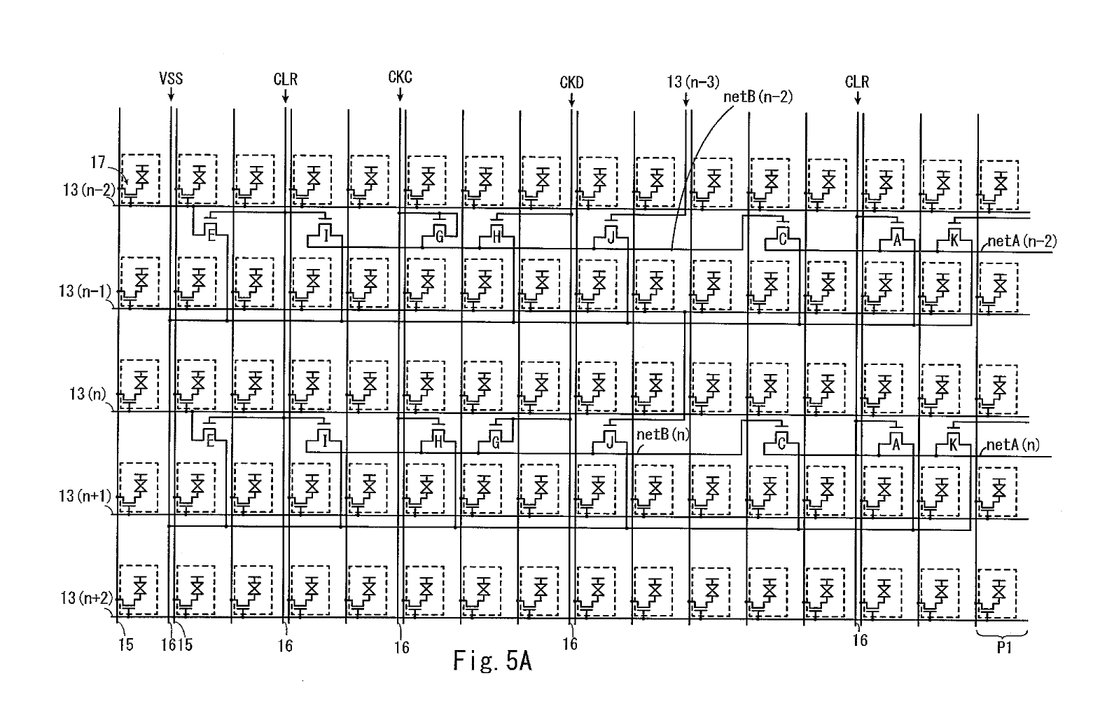

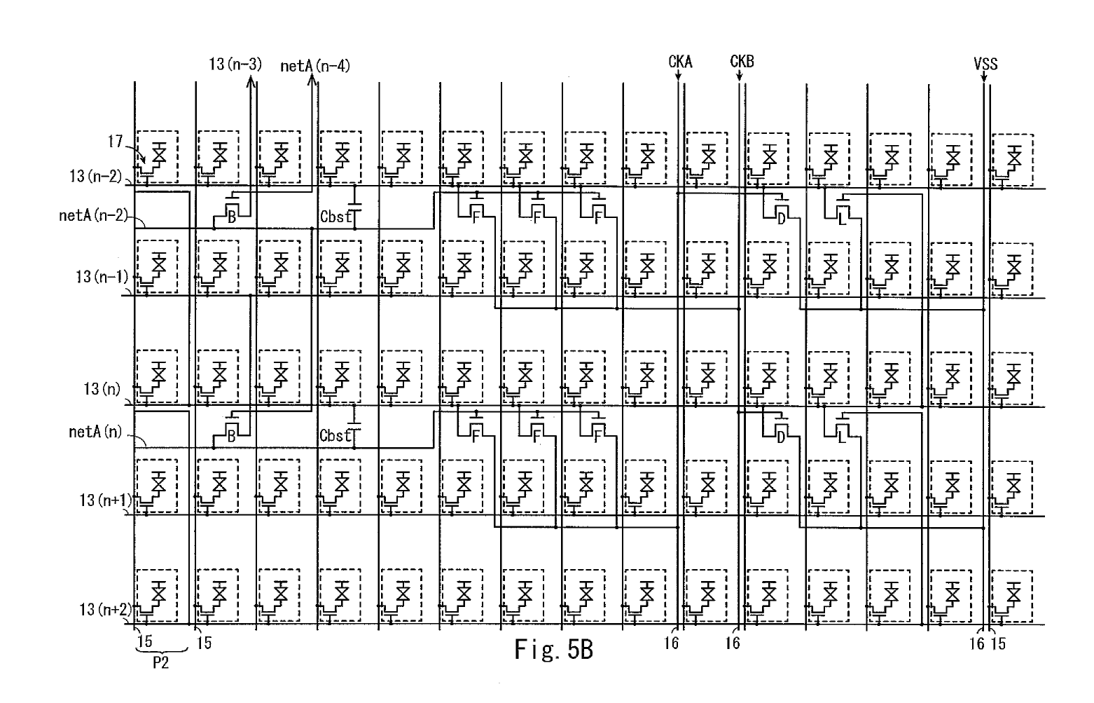

Further, in the vicinity of the intersection of one gate line 13 and one source line 15 in each pixel, a pixel thin film transistor (TFT) 17 (see FIGS. 5A, 5B and the like) connected to the gate line 13 and the source line 15 is arranged. At each pixel, a pixel electrode (not shown) is arranged, and the pixel electrode is connected to the drain terminal of the pixel TFT.

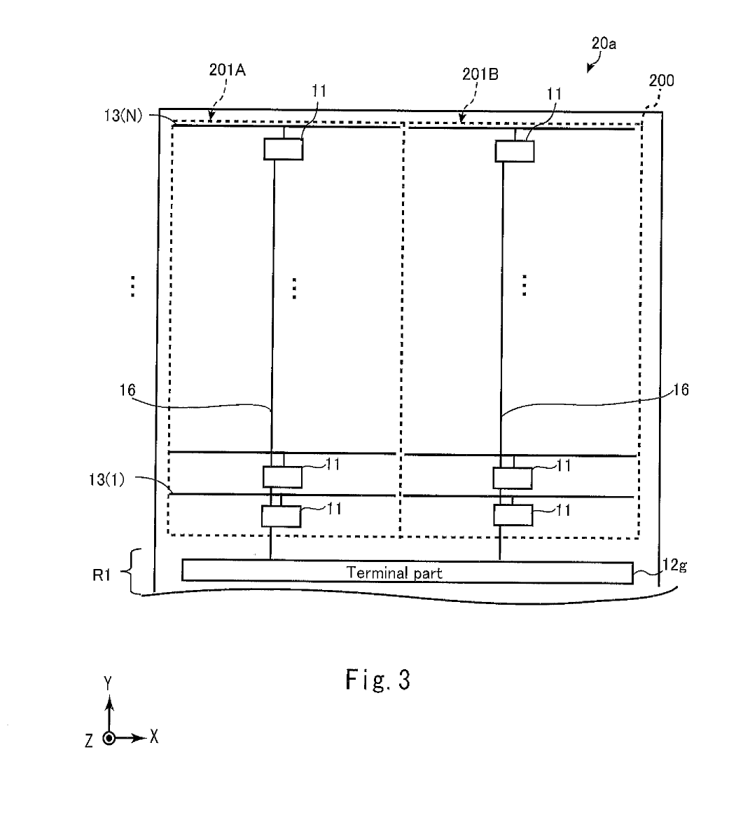

In each of the areas 201A and 201B, a plurality of gate drivers 11 for switching the gate lines 13 in the area into a selected state or a non-selected state are provided. FIG. 3 is a schematic diagram illustrating a schematic configuration of the active matrix substrate 20a in which the illustration of the source lines 15 and the terminal part 12s is omitted. As illustrated in FIG. 3, in the frame region R1, a terminal part 12g is arranged. The terminal part 12g is connected with the display control circuit 4 (see FIG. 1), and supplies control signals supplied from the display control circuit 4 via control lines 16 to each gate driver 11.

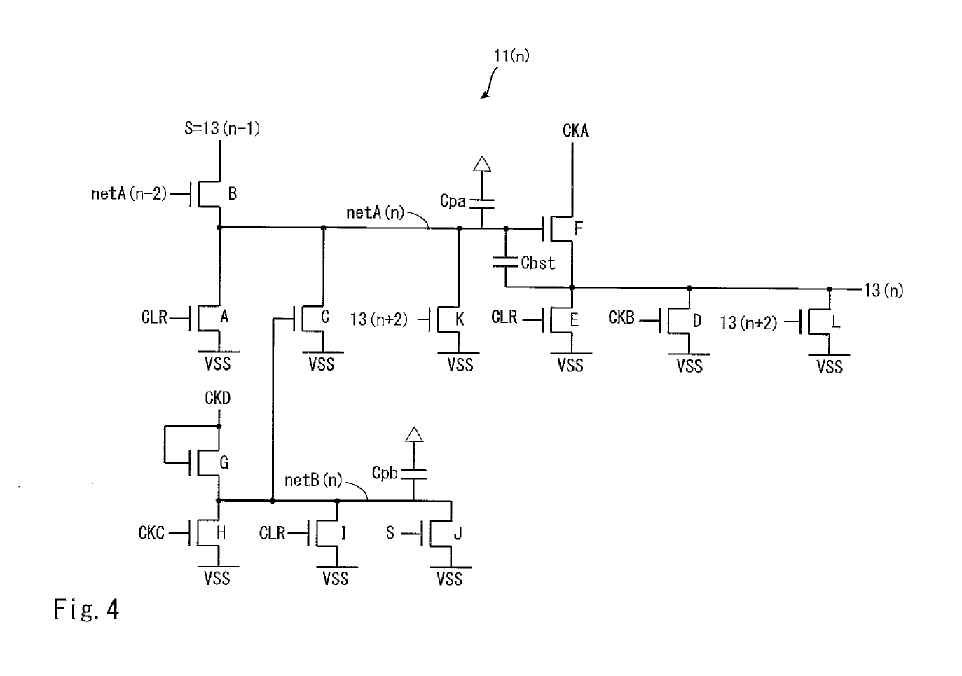

Next, the following description describes the gate driver 11. FIG. 4 illustrates an equivalent circuit of one gate driver 11 in the present embodiment. In the example in FIG. 4, an equivalent circuit of the gate driver 11(n) that drives the gate line 13(n) (n: integer, 1≦n≦N) is illustrated.

As illustrated in FIG. 4, the gate driver 11(n) has TFTs indicated by alphabetic characters A to L (hereinafter referred to as TFTs-A to -L), and a capacitor Cbst.

In FIG. 4, an internal line to which a source terminal of TFT-B, drain terminals of TFT-A, TFT-C, and TFT-K, a gate terminal of TFT-F, and one of electrodes of the capacitor Cbst are connected is referred to as “netA”. Further, an internal line to which a source terminal of TFT-G, drain terminals of TFT-H, TFT-I, and TFT-J, and a gate terminal of TFT-C are connected is referred to as “netB”.

Since the gate drivers 11 are provided in the area 201A or the area 201B, netA and netB have parasitic capacitances Cpa and Cpb, respectively, between the same and the source lines 15 (see FIG. 2) or other elements provided in the pixels.

The drain terminal of TFT-A is connected with netA, a reset signal CLR is supplied to the gate terminal, and the power source voltage signal VSS is supplied to the source terminal. The TFT-A pulls down netA(n) to a low (L) level (VSS) according to the potential of the reset signal CLR.

Regarding TFT-B, netA in the gate driver 11(n−2) that drives the gate line 13(n−2) (hereinafter referred to as “netA(n−2)”) is connected to the gate terminal thereof, the drain terminal thereof is connected with the gate line 13(n−1), and the source terminal thereof is connected with netA in the gate driver 11(n) (hereinafter referred to as “netA(n)”).

To the gate terminal and the drain terminal of TFT-B in the gate driver 11(1) that drives the gate line 13(1), a startpulse signal is supplied as a set signal S from the display control circuit 4 at a predetermined timing.

Regarding TFT-C, the gate terminal thereof is connected with netB(n), the drain terminal thereof is connected with netA(n), and to the source terminal thereof, a power source voltage signal VSS is supplied.

Regarding TFT-K, the gate terminal thereof is connected with the gate line 13(n+2), the drain terminal thereof is connected with netA(n), and to the source terminal thereof, the power source voltage signal VSS is supplied.

Regarding TFT-F, the gate terminal thereof is connected with netA(n), the source terminal thereof is connected to the gate line 13(n), and to the drain terminal thereof, a clock signal CKA is supplied. It should be noted that TFT-F has to have a great channel width since it drives the gate line 13 on which a relatively heavy load is applied. In the equivalent circuit illustrated in FIG. 5, TFT-F is represented by one TFT, but TFT-F is formed with a plurality of TFTs connected in parallel.

Regarding the capacitor Cbst, one of electrodes thereof is connected with netA(n), and the other electrode thereof is connected with the gate line 13(n).

Regarding TFT-E, the drain terminal thereof is connected with the gate line 13(n), the reset signal CLR is supplied to the gate terminal thereof, and a power source voltage signal VSS is supplied to the source terminal thereof.

Regarding TFT-D, the drain terminal thereof is connected with the gate line 13(n), a clock signal CKB is supplied to the gate terminal, and the power source voltage signal VSS is supplied to the source terminal.

Regarding TFT-L, the drain terminal thereof is connected with the gate line 13(n), the gate terminal thereof is connected with the gate line 13(n+2), and the power source voltage signal VSS is supplied to the source terminal.

Regarding TFT-G, the gate terminal thereof and the drain terminal thereof are connected, a clock signal CKD is supplied to the gate terminal and the drain terminal, and the source terminal is connected to netB(n).

Regarding TFT-H, the drain terminal thereof is connected to netB(n), a clock signal CKC is supplied to the gate terminal thereof, and the power source voltage signal VSS is supplied to the source terminal thereof.

Regarding TFT-I, the drain terminal thereof is connected with netB(n), the reset signal CLR is supplied to the gate terminal thereof, and the power source voltage signal VSS is supplied to the source terminal thereof.

Regarding TFT-J, the drain terminal thereof is connected with netB(n), the gate terminal thereof is connected with the gate line 13(n−1), and the power source voltage signal VSS is supplied to the source terminal thereof. To the gate terminal of TFT-J in the gate driver 11(1), the startpulse signal is supplied as a set signal S from the display control circuit 4.

Next, an exemplary arrangement of respective elements of the gate driver 11 is described below. FIGS. 5A and 5B are schematic diagrams that illustrate arrangement layouts of respective elements of the gate driver 11(n), and the gate driver 11(n−2) that drives the gate line 13(n−2), arranged in, for example, the area 201A. FIGS. 5A and 5B are assumed to be continuous to each other, with the column P1 illustrated in FIG. 5A and the column P2 illustrated in FIG. 5B being adjacent to each other.

In these diagrams, the illustration of the arrangement layout of the gate driver 11(n−1) and the gate driver 11(n+1) is omitted; these gate drivers are arranged in columns different from those where the gate driver 11(n) and the gate driver 11(n−2) are arranged, in the same manner as that where the gate driver 11(n) and the gate driver 11(n−2) are arranged. Here, thought the illustration is omitted, the elements of the gate driver 11 are arranged in the area 201B in the same manner as the manner in the area 201A.

As illustrated in FIGS. 5A and 5B, TFTs-A to -L, the capacitor Cbst, netA(n−2), and netB(n−2) of the gate driver 11(n−2) are arranged between the gate line 13(n−2) and the gate line 13(n−1). TFTs-A to -L, the capacitor Cbst, netA(n), and netB(n) of the gate driver 11(n) are arranged between the gate line 13(n) and the gate line 13(n+1).

As illustrated in FIGS. 5A and 5B, the control lines 16 supplying the clock signals CKA to CKD, the reset signal CLR, and the power source voltage signal VSS are led out of the terminal part 12g (see FIG. 3), and are connected with the TFTs to which the control signals supplied through the control lines 16 are input.

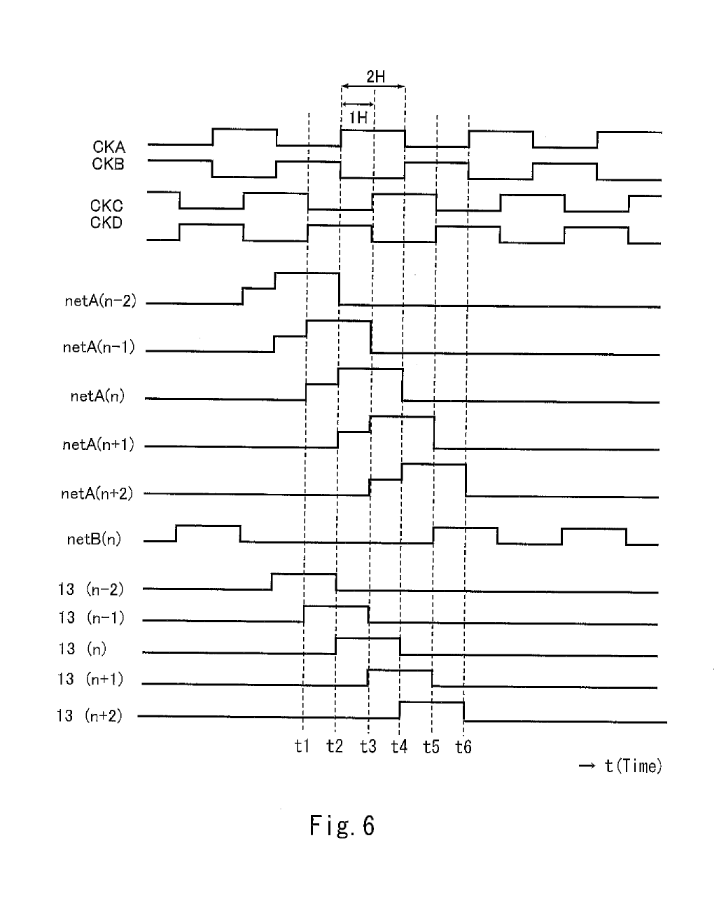

Next, the following description describes operations of the gate driver 11. FIG. 6 illustrates exemplary waveforms of the clock signals CKA to CKD, and a timing chart when the gate driver 11(n) drives the gate line 13(n).

As illustrated in FIG. 6, the clock signals CKA, CKB, CKC, and CKD are control signals having potentials that change to the high (H) level or to the low (L) level every two horizontal scanning periods (2H).

The phases of the clock signals CKA and CKB are opposite, and so are the phases of the clock signals CKC and CKD. Further, the phases of the clock signals CKA and CKC are shifted by ¼ cycle, and so are the phases of the clock signals CKC and CKB. Still further, the phases of the clock signals CKB and CKD are shifted by ¼ cycle, and so are the phases of the clock signals CKD and CKA.

As illustrated in FIGS. 5A and 5B, the clock signals CKB, CKA, CKD, and CKC are supplied to the TFTs-D, -F, -G, and -H of the gate driver 11(n), respectively, whereas the clock signals CKA, CKB, CKC, and CKD are supplied to the TFTs-D, -F, -G, and -H of the gate driver 11(n−2), respectively. In other words, the clock signals having phases opposite to each other are supplied to the gate driver 11(n) and the gate driver 11(n−2).

Though the illustration of the reset signal CLR is omitted in FIG. 6, the reset signal CLR is a control signal that is maintained at the H level during a certain period every one perpendicular scanning period. When the reset signal CLR is input to the gate driver 11, potentials of netA and netB in the gate driver 11, and the gate line 13 driven by the gate driver 11, fall to the L level. The following description describes the operations of the gate driver 11(n), while referring to FIGS. 4 and 6.

At a timing of time t1 in FIG. 6, the gate line 13(n−1) is switched to the selected state, the voltage at the H level of the gate line 13(n−1) is input as a set signal S to the drain terminal of TFT-B of the gate driver 11(n). Further, the voltage of netA(n−2) is input to the gate terminal of TFT-B. The potential of netA(n−2) is at H level before time t1, and TFT-B is turned ON at time t1. TFT-B remains in the in the ON state until time 2 when the potential of netA(n−2) falls to the L level, and netA(n) is precharged to the potential at the H level of the gate line 13(n−1) from time t1 to t2.

The gate terminal of TFT-F is turned ON since the voltage at the H level of netA(n) is input thereto. At time t1, TFT-D is turned ON since a voltage at the H level of the clock signal CKB is input to the gate terminal of TFT-D, and the voltage (VSS) at the L level is input to the gate line 13(n).

Further, at time t1, the potential of the clock signal CKD is at the H level, and the potential of the clock signal CKC is at the L level. This causes TFT-G to be turned ON, and TFT-H to be turned OFF. The voltage at the H level of the gate line 13(n−1) is input as a set signal S to the gate terminal of TFT-J, whereby TFT-J is turned ON. NetB(n) is therefore maintained at the potential at the L level, and TFT-C is turned OFF.

At time t2, the potential of the clock signal CKA rises to the H level, a voltage at the H level of the clock signal CKA is input to the gate line 13(n) via TFT-F. As the potential of the gate line 13(n) rises, netA(n) is charged to a potential higher than the potential at the H level of the clock signal CKA by the capacitor Cbst connected between netA(n) and the gate line 13(n).

At time t2, the potential of the gate line 13(n−1) is at the H level, TFT-J remains in the ON state. At time t3, the potential of the clock signal CKC rises to the H level, and remains at the H level until time t4. During this period, TFT-H is turned ON, and netB(n) is maintained at the potential at the L level.

Further, at time t2, the potential of the clock signal CKB shifts from the H level to the L level, and TFT-D is turned OFF. This causes the potential at the H level of the clock signal CKA (selection voltage) to be output to the gate line 13(n) during a period from time t2 to time t4, thereby causing the gate line 13(n) to be switched to the selected state.

The gate driver 11(n+1) driving the gate line 13(n+1) operates in the same manner as the gate driver 11(n), using the potential of the gate line 13(n) as the set signal S, and the gate driver 11(n+2) driving the gate line 13(n+2) operates in the same manner as the gate driver 11(n), using the potential of the gate line 13(n+1) as the set signal S. As a result, the gate line 13(n+1) is switched to the selected state at the timing of time t3, and the gate line 13(n+2) is switched to the selected state at the timing of time t4.

The potential of the clock signal CKB rises to the H level at time t4, whereby TFT-D is turned ON. Further, at time t4, the potential of the gate line 13(n+2) rises to the H level, whereby TFT-K and TFT-L are also turned ON. This causes a voltage at the L level to be input to the gate line 13(n) via TFT-D and TFT-L, whereby the gate line 13(n) is switched to the non-selected state. Further, a voltage at the L level is input to netA(n) via TFT-K. Here, since the potential of the clock signal CKC is at the H level and TFT-H is in the ON state, the potential of netB(n) is maintained at the L level.

Subsequently, at time t5, when the potential of the clock signal CKD rises to the H level and the potential of the clock signal CKC falls to the L level, TFT-H is turned OFF and TFT-G is turned ON. This causes netB(n) to be charged to a potential that is smaller by the threshold value voltage of TFT-G, with respect to the potential at the H level of the clock signal CKD. Here, since TFT-K and TFT-L are in the ON state and TFT-C is turned ON, netA(n) and the gate line 13(n) are maintained at the potential at the L level.

After time t6, at a timing when the clock signal CKB has a potential at H level, the gate line 13(n) is maintained at the potential at the L level via TFT-D.

Further, after time t6, at a timing when the clock signal CKD has a potential at H level, netB(n) is charged to the potential at the H level, while netA(n) maintains a potential at the L level via TFT-C.

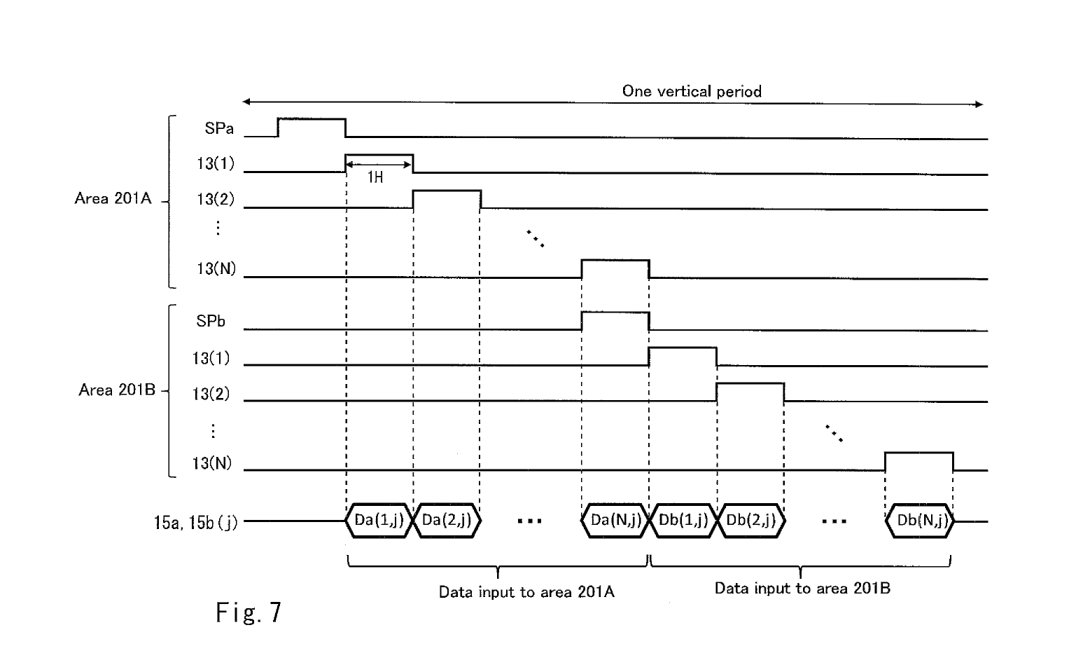

Next, the following description describes an operation of writing data signals to the pixels in the areas 201A and 201B. FIG. 7 is a timing chart when data signals are written in the areas 201A and 201B. Waveforms of the gate lines 13(1) to 13(N) in this diagram are waveforms during one horizontal scanning period (1H) that is latter one of two horizontal scanning periods (2H) when the gate lines 13 have a potential at the H level. In other words, the waveforms of the gate lines 13(n) in FIG. 7 are waveforms of the gate lines 13(n) during one horizontal scanning period from time t3 to time t4 illustrated in FIG. 6.

After supplying the reset signal CLR to the terminal part 12g, the display control circuit 4 supplies, to the terminal part 12g, a startpulse signal SPa as a set signal S for the gate driver 11(1) in the area 201A, and supplies control signals (the clock signals CKA to CKD) to the terminal part 12g. This causes the gate lines 13(1) to 13(N) in the area 201A to be sequentially driven by the gate drivers 11 in the area 201A.

The gate lines 13(1) to 13(N) in the area 201A are sequentially driven, and the source driver 3 supplies data signals to be written in the pixels of the respective rows in the area 201A, to the terminal part 12s, at respective timings when one horizontal scanning period (1H) elapses from the respective starts of driving of the gate lines 13(1) to 13(N) in the area 201A.

This allows data signals Da(1, j), Da(2, j) . . . Da(N, j) to be supplied to the source lines 15a(j) (j: integer, 1≦j≦M) in the area 201A, respectively, from the terminal part 12s. Further, to the source lines 15b(j) in the area 201B as well, the data signals Da(1, j), Da(2, j) . . . Da(N, j) are supplied, via the source lines 15a(j), respectively.

As a result, the data signals Da(1, j), Da(2, j) . . . Da(N, j) are sequentially input to the pixel electrodes connected to the pixel TFTs connected with the source lines 15a(j), at respective timings when one horizontal scanning period (1H) elapses from the respective starts of driving of the gate lines 13(1) to 13(N) in the area 201A, whereby data signals are written in all of the pixels in the area 201A. Here, since all of the gate lines 13 in the area 201B have potentials at the L level, data signals supplied to the source lines 15b(j) are not written in the pixels in the area 201B.

Subsequently, the display control circuit 4 supplies, to the terminal part 12g, a startpulse signal SPb as a set signal S for the gate driver 11(1) in the area 201B, and at the same time, supplies control signals (the clock signals CKA to CKD) to the terminal part 12g. This causes the gate lines 13b(1) to 13b(N) to be sequentially driven by the gate drivers 11 in the area 201B.

The gate lines 13(1) to 13(N) in the area 201B are sequentially driven, and the source driver 3 supplies data signals to be written in the pixels of the respective rows in the area 201B, to the terminal part 12s, at respective timings when one horizontal scanning period (1H) elapses from the respective starts of driving of the gate lines 13(1) to 13(N) in the area 201B. This causes data signals Db(1, j), Db(2, j) . . . Db(N, j) to be supplied from the terminal part 12s to the source lines 15a(j). Further, the data signals Db(1, j), Db(2, j) . . . Db(N, j) are supplied via the source lines 15a(j) to the source lines 15b(j).

As a result, at respective timings when one horizontal scanning period (1H) elapses from the respective starts of driving of the gate lines 13(1) to 13(N) in the area 201B, data signals Db(1, j), Db(2, j) . . . Db(N, j) are input to the source lines 15b(j), respectively, whereby data signals are written in all of the pixels in the area 201B. Here, since the potentials of all of the gate lines 13 in the area 201A are at the L level, the data signals supplied to the source lines 15a(j) are not written in the pixels in the area 201A.

In this way, by driving the gate lines 13 in the area 201B after driving the gate lines 13 in the area 201A, data signals can be written in all of the pixels of the areas 201A and 201B.

In the example described above, the startpulse signal SPb is supplied as the set signal S from the display control circuit 4 to the gate driver 11(1) in the area 201B, but the potential of the gate line 13(N) in the area 201A may be supplied in place of the startpulse signal SPb.

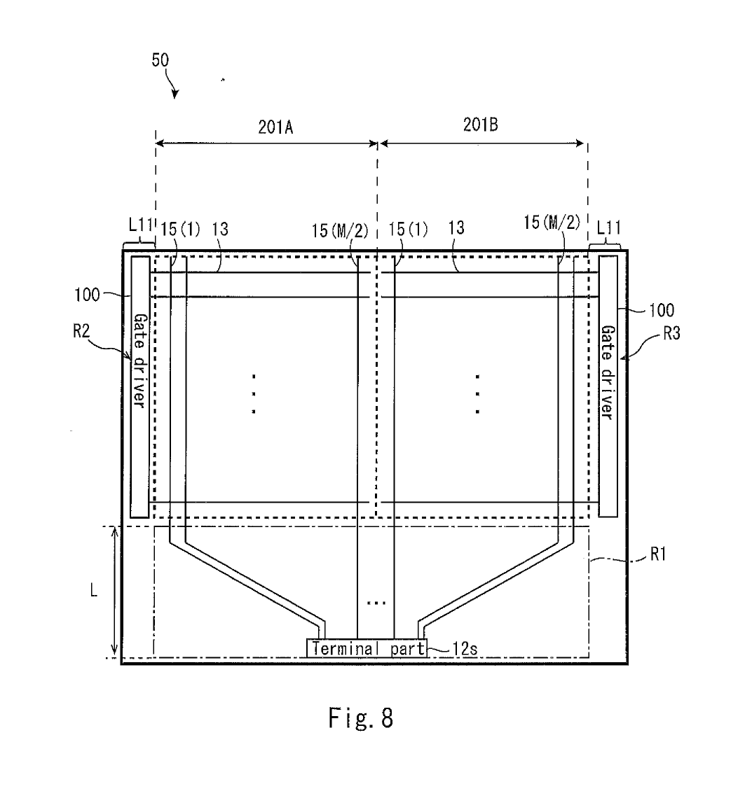

Here, the following description describes, as a comparative example, an active matrix substrate 50 in which the terminal part 12s, the gate lines 13, and the source lines 15 of the active matrix substrate 20a in the present embodiment are provisionally arranged as illustrated in FIG. 8. In frame regions R2 and R3 in the right and left parts of the active matrix substrate 50, gate drivers 100 for driving the gate lines 13 in areas 201A and 201B are provided, respectively. In this case, the width L11 in the gate line 13 extending direction of each of the frame regions R2 and R3 is required to be a width enough to arrange the gate driver 100. On the other hand, in Embodiment 1 described above, the gate drivers 11 for driving the gate lines 13 in the areas 201A and 201B are arranged in the areas, respectively (see FIGS. 2, 3). This allows the width in the gate line 13 extending direction of each of the right and left frame regions R1 and R2 in the active matrix substrate 20a to be narrower than the width of each of the frame regions R1 and R2 illustrated in FIG. 8.

Further, since M/2 source lines 15 are routed from the terminal part 12s to each of the areas 201A and 201B on the active matrix substrate 50 illustrated in FIG. 8, the frame region R1 is required to have a width L for routing M source lines 15 from the terminal part 12s. On the other hand, in Embodiment 1 described above, as illustrated in FIG. 2, the source lines 15a are routed from the terminal part 12s to the area 201A, without being bent. The source lines 15b are, at one-side ends thereof, connected to portions 150a of the source lines 15a in the frame region R1, and are routed to the area 201B. In Embodiment 1, therefore, the frame region R1 is required only to have a width L for routing M/2 source lines 15a from the terminal part 12s, and hence, the width of the frame region R1 can be narrower than the width of the frame region R1 illustrated in FIG. 8.

### Embodiment 2

The display region 200 of the active matrix substrate 20a of the present embodiment is different from Embodiment 1 in the point that four pixel regions having independent pixel groups, respectively, are arrayed. The following description describes configurations thereof different from those in Embodiment 1.

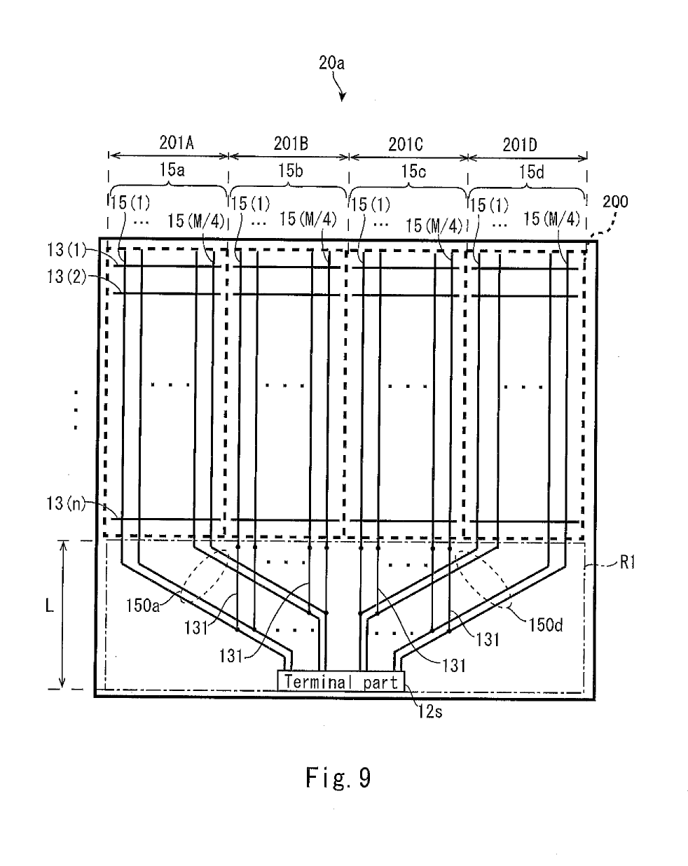

FIG. 9 is a schematic diagram illustrating an exemplary arrangement of source lines on the active matrix substrate 20a in the present embodiment. As illustrated in FIG. 9, in the present embodiment, N gate lines 13 and M/4 source lines 15 (15a, 15b, 15c, 15d) are formed in each of four areas 201A, 201B, 201C, and 201D. In other words, the active matrix substrate 20a includes M source lines 15 in total, as is the case with Embodiment 1. Hereinafter, when the source lines in the respective areas are not distinguished, they are referred to as the “source lines 15” collectively.

Though the illustration is omitted in FIG. 9, gate drivers 11 for driving the gate lines 13 in each area are provided in the area, as is the case with Embodiment 1. Further, a terminal part 12s is provided in the frame region R1.

As illustrated in FIG. 9, source lines 15a in the area 201A and source lines 15d in the area 201D are routed separately from the terminal part 12s. The source lines 15a and the source line 15d are arranged so as to be approximately horizontally symmetric with respect to the boundary between the area 201B and the area 201C. The source lines 15b in the area 201B are connected with portions 150a of the source lines 15a arranged in the frame region R1 through connection lines 131. Further, the source lines 15c in the area 201C are connected with portions 150d of the source lines 15d arranged in the frame region R1 through connection lines 131.

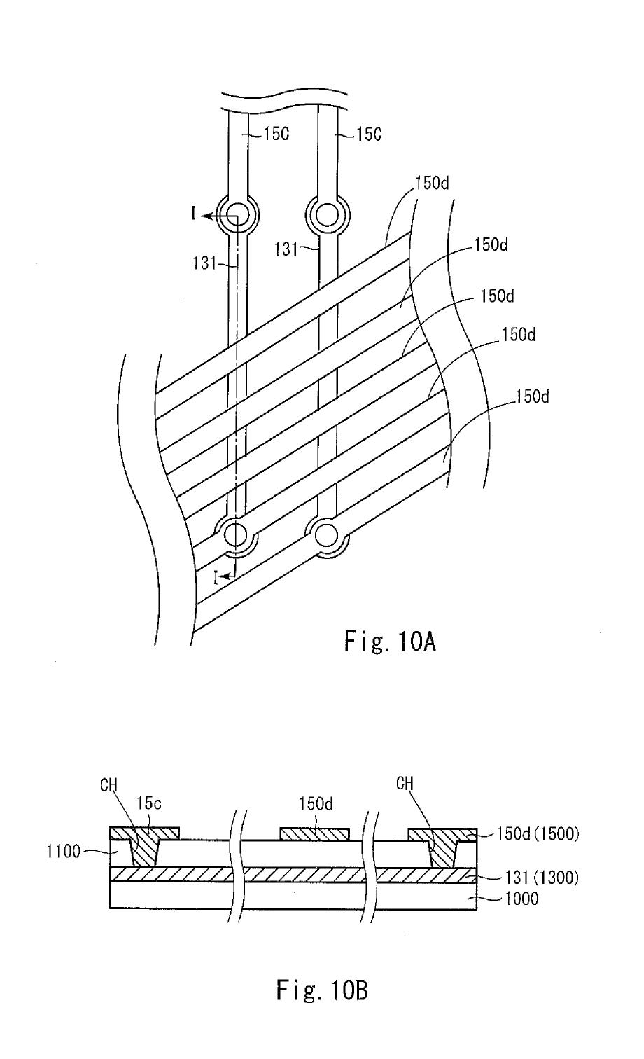

FIG. 10A is an enlarged schematic diagram illustrating a connection part where the source lines 15d and the source lines 15c are connected through the connection lines 131. As illustrated in FIG. 10A, the portions 150d of the source lines 15d arranged in the frame region R1 (hereinafter referred to as the source line portions 150d) are arranged approximately in parallel with one another, with a certain angle being formed between the source line portions 150d and the connection lines 131. Each connection line 131 extends approximately linearly from an end of one of the source lines 15c arranged in the area 201C to the source line portions 150d of the source line 15d corresponding to the source line 15c.

FIG. 10B is a cross-sectional view of the connection part illustrated in FIG. 10A where the source line 15c and the source line portion 150d are connected with the connection line 131, the cross-section being taken along line I-I in FIG. 10A. As illustrated in FIG. 10B, the connection line 131 is formed on the first metal layer 1300 formed on the substrate 1000 composing the active matrix substrate 20a. Though not illustrated in this drawing, the gate lines 13 are formed on the first metal layer 1300.

In FIG. 10B, an insulating film 1100 is provided to cover the connection line 131, and a second metal layer 1500 is formed on the insulating film 1100. On the second metal layer 1500, the source line 15c and the source line portions 150d are formed. The source line 15c and the source line portion 150d are connected with the connection line 131 though contact holes CH provided in the insulating film 1100.

In this way, the connection lines 131 are formed in the first metal layer 1300 that is different from the second metal layer 1500 in which the source line portions 150d and the source lines 15c are formed. This makes it possible to connect the source lines 15d and the source lines 15c, without causing the source line portions 150d and the source lines 15c to intersect with one another.

With reference to the above-described example, the structure of connection between the source line 15c and the source line portion 150d is described in the foregoing description. The structure of connection between the source line 15b and the portion 150a of the source line 15a arranged in the frame region R1 (hereinafter referred to as the source line portion 150a) is identical to the above-described structure.

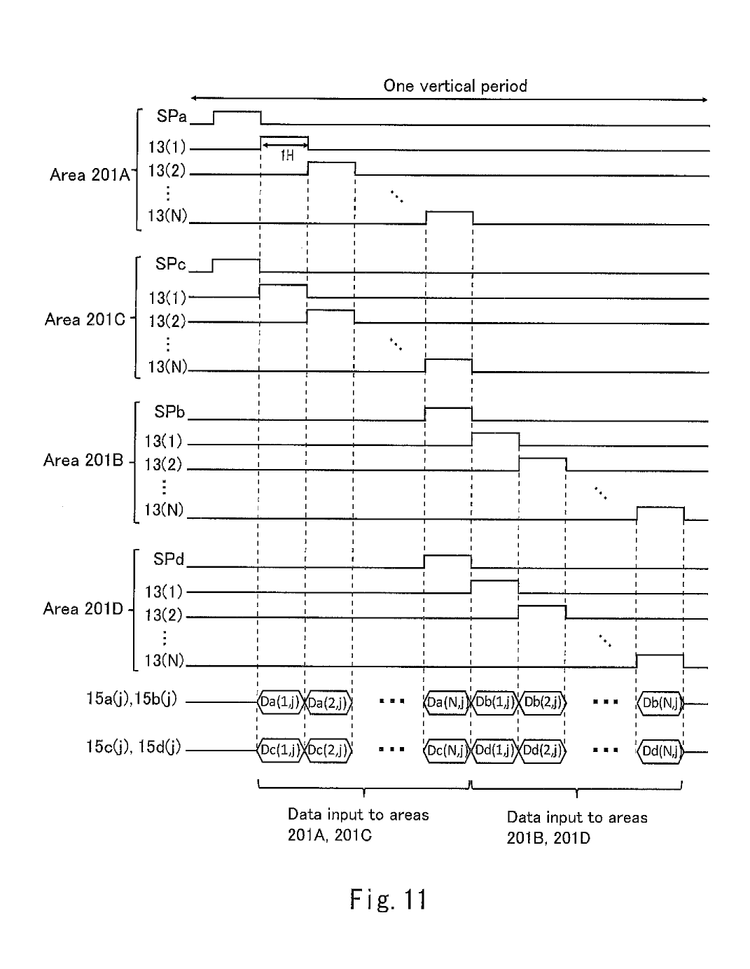

Next, the following description describes a data signal writing operation in the present embodiment. FIG. 11 illustrates a timing chart of a data signal writing operation in the present embodiment. As is the case with FIG. 7 mentioned above, the waveforms of the gate lines 13(1) to 13(N) in this diagram are waveforms during one horizontal scanning period (1H) that is latter one of two horizontal scanning periods (2H) when the gate lines 13 have a potential at the H level. In other words, the waveforms of the gate lines 13(n) in FIG. 11 are waveforms of the gate lines 13(n) during one horizontal scanning period from time t3 to time t4 illustrated in FIG. 6.

After supplying the reset signal CLR to the terminal part 12g, the display control circuit 4 supplies, to the terminal part 12g, startpulse signals SPa and SPc as set signals S for the gate drivers 11(1) in the areas 201A and area 201C, and supplies control signals (the clock signals CKA to CKD) to the terminal part 12g, and at the same time, supplies control signals (the clock signals CKA to CKD) to the terminal part 12g.

This causes the gate lines 13(1) to 13(N) in the area 201A and the gate lines 13(1) to 13(N) in the area 201C to be sequentially driven at the same timings by the gate drivers 11 in the areas 201A and 201C.

The gate lines 13(1) to 13(N) in the area 201A and the area 201C are sequentially driven, and at respective timings when one horizontal scanning period (1H) elapses from the respective starts of driving of the gate lines 13(1) to 13(N) in the area 201A and the area 201C, data signals Da (Da(1, j), Da(2, j) . . . Da(N, j)) to be written in the pixels of the respective rows in the area 201A, and data signals Dc (Dc(1, j), Dc(2, j) . . . Dc(N, j)) to be written in the pixels of the respective rows in the area 201C (j: integer, 1≦j≦M/4), are supplied from the source driver 3 to the terminal part 12s.

This allows the data signals Da(1, j), Da(2, j) . . . Da(N, j) to be sequentially input to the source lines 15a(j) at respective timings when one horizontal scanning period (1H) elapses from the respective starts of driving of the gate lines 13(1) to 13(N) in the area 201A, whereby the data signals are written in all of the pixels in the area 201A. Further, this allows the data signals Dc(1, j), Dc(2, j) . . . Dc(N, j) to be sequentially input through the connection lines 131 to the source lines 15c(j) at respective timings when one horizontal scanning period (1H) elapses from the respective starts of driving of the gate lines 13(1) to 13(N) in the area 201C, whereby the data signals are written in all of the pixels in the area 201C. Here, data signals are supplied to the source lines 15b(j) and 15d(j) as well, but since the potentials of all of the gate lines 13 in the areas 201B and 201D are at the L level, the data signals are not written in the pixels in the areas 201B and 201D.

Next, the display control circuit 4 supplies, to the terminal part 12g, startpulse signals SPb and SPd as set signals S for the gate drivers 11(1) in the areas 201B and 201D, and supplies control signals (the clock signals CKA to CKD) to the terminal part 12g.

This causes the gate lines 13b(1) to 13b(N) in the area 201B and the area 201D to be sequentially driven by the gate drivers 11 in the areas 201B and 201D at the same timings.

The gate lines 13 in the areas 201B and the area 201D are sequentially driven, and at respective timings when one horizontal scanning period (1H) elapses from the respective starts of driving of the gate lines 13 in the areas 201B and the area 201D, data signals Db (Db(1, j), Db(2, j) . . . Db(N, j)) to be written in the pixels of the respective rows in the area 201B, and data signals Dd (Dd(1, j), Dd(2, j) . . . Dd(N, j)) to be written in the pixels of the respective columns in the area 201D, are supplied from the source driver 3 to the terminal part 12s.

This allows the data signals Db(1, j), Db(2, j) . . . Db(N, j) to be sequentially input through the connection lines 131 to the source lines 15b(j) at respective timings when one horizontal scanning period (1H) elapses from the respective starts of driving of the gate lines 13(1) to 13(N) in the area 201B, whereby the data signals are written in all of the pixels in the area 201B. Further, this allows the data signals Dd(1, j), Dd(2, j) . . . Dd(N, j) to be sequentially input to the source lines 15d(j) at respective timings when one horizontal scanning period (1H) elapses from the respective starts of driving of the gate lines 13(1) to 13(N) in the area 201D, whereby the data signals are written in all of the pixels in the area 201D. Here, data signals are supplied to the source lines 15a(j) and 15c(j) as well, but since the potentials of all of the gate lines 13 in the areas 201A and 201C are at the L level, the data signals are not written in the pixels in the areas 201A and 201C.

In Embodiment 2 described above, first, the gate lines 13 in the areas 201A and 201C are driven, and data signals are written in the pixels in these areas. Then, after the writing of data signals in the areas 201A and 201C ends, the gate lines 13 in the areas 201B and 201D are driven, and data signals are written to the pixels in these areas. In this way, data signals can be written in all of the pixels in the active matrix substrate 20a.

Further, in Embodiment 2, M/2 source lines 15 in total, which are M/4 source lines 15a in the area 201A and M/4 source lines 15d in the area 201D, are routed from the terminal part 12s; among these, the source lines 15a and the source lines 15d are routed approximately horizontally symmetrically with respect to the boundary between the areas 201B and 201C interposed therebetween. The width L of the frame region R1, therefore, is required only to be a width enough for routing M/4 source lines 15 from the terminal part 12s. As compared with the case where the source lines 15 in all of the areas are routed from the terminal part 12s, therefore, the width L of the frame region R1 can be reduced.

The foregoing description of Embodiment 2 refers to an exemplary case where all of the source lines 15b and 15c are connected through the connection lines 131 to the source lines 15a and 15d, respectively, but the configuration may be as follows. For example, among the source lines 15b and 15c arranged in the areas 201B and 201C, the source lines 15b and 15c that when extended intersect with the source lines 15b and 15c are connected through the connection lines 131 with the source lines 15a and 15d, and the other source lines 15b and 15c are directly connected with the corresponding source lines 15a and 15d.

Further, the foregoing description of Embodiment 2 refers to an exemplary case where the connection lines 131 are formed in the first metal layer 1300, but the connection lines 131 may be formed in the second metal layer 1500. In this case, however, the source line portions 150a and 150d are formed in the first metal layer 1300, and the source line portions 150a and 150d and the source lines 15a and 15d are connected through contacts. Then, the source lines 15b and 15c may be connected through the connection lines 131 with the source line portions 150a and 150d.

### Embodiment 3

The present embodiment is different from Embodiment 2 described above in the following point: the source lines 15a in the area 201A and the source lines 15b in the area 201B are connected through switching elements, and the source lines 15c in the area 201C and the source lines 15d in the area 201D are connected through switching elements.

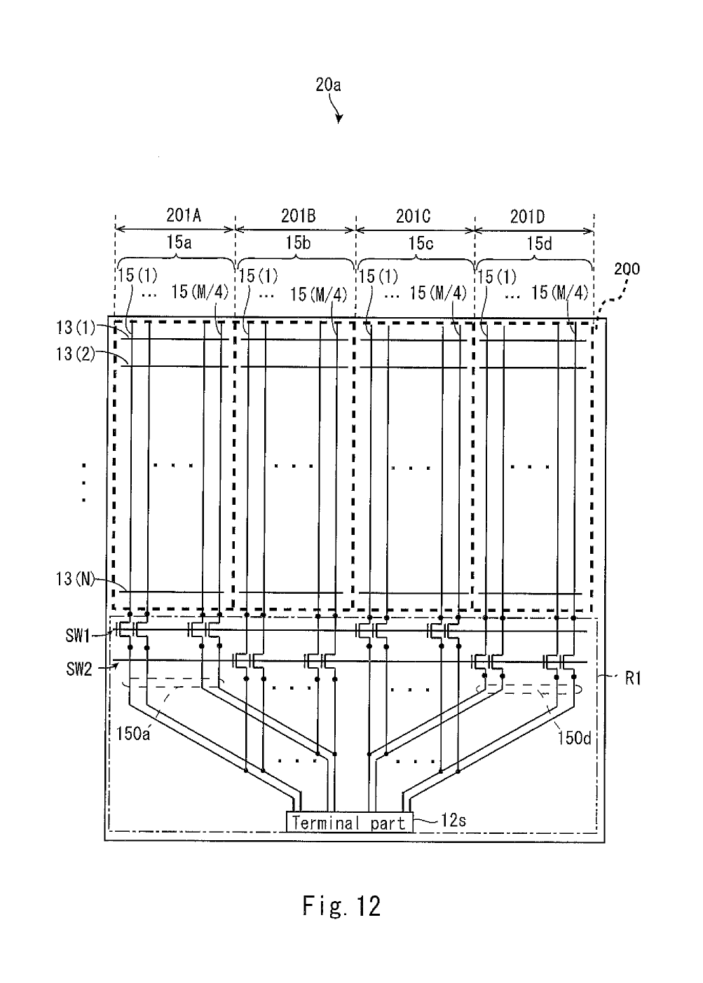

FIG. 12 is a schematic diagram illustrating exemplary connection of the source lines 15a to 15d in the areas 201A to 201D in the present embodiment. In this diagram, the illustration of the gate drivers 11 and the terminal part 12g is omitted. The following description describes configurations different from those in Embodiment 2.

As illustrated in FIG. 12, the source lines 15a and the source lines 15c are connected with switching elements SW1 in the frame region R1, and the source lines 15b and the source lines 15d are connected with switching elements SW2 in the frame region R1.

The source lines 15a are connected through the switching elements SW1 with the terminal part 12s. The source lines 15b are connected, through the switching elements SW2, with the source line portions 150a connected with the terminal part 12s. Further, the source lines 15d are connected through the switching elements SW2 with the terminal part 12s. The source lines 15c are connected through the switching elements SW1 with the source line portions 150d connected with the terminal part 12s.

The source lines 15a are conductive with the terminal part 12s when the switching elements SW1 are in the ON state. The source lines 15d are conductive with the terminal part 12s when the switching elements SW2 are in the ON state. The source lines 15b are conductive with the terminal part 12s through the source line portions 150a when the switching elements SW2 are in the ON state. The source lines 15c are conductive with the terminal part 12s through the source line portions 150d when the switching elements SW1 are in the ON state.

The switching elements SW1 and SW2 are connected with the display control circuit 4 (see FIG. 2). To the gate terminals of the switching elements SW1 and SW2, a voltage at the H level or the L level is supplied from the display control circuit 4

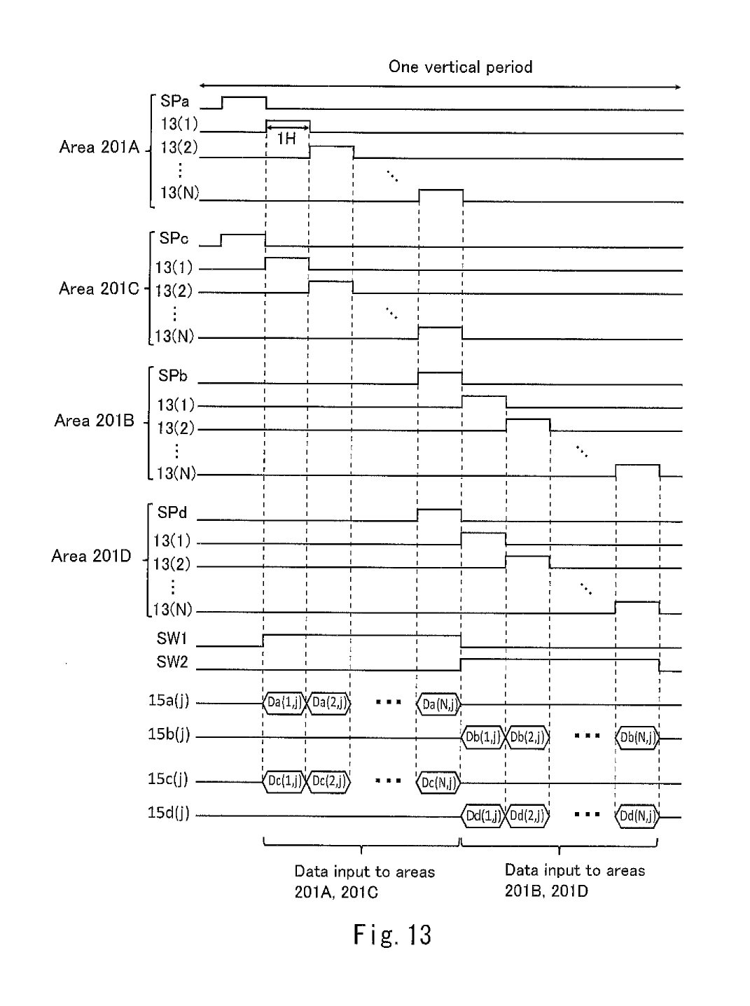

FIG. 13 illustrates a timing chart of a data signal writing operation in the present embodiment. The present embodiment is identical to Embodiment 2 regarding the point that data signal writing is performed with respect to the areas 201B and 201D after data signal writing with respect to the areas 201A and 201C, but the present embodiment is different from Embodiment 2 regarding the following point. As is the case with FIG. 7 mentioned above, the waveforms of the gate lines 13(1) to 13(N) in this diagram are waveforms during one horizontal scanning period (1H) that is latter one of two horizontal scanning periods (2H) when the gate lines 13 have a potential at the H level. In other words, the waveforms of the gate lines 13(n) in FIG. 13 are waveforms of the gate lines 13(n) during one horizontal scanning period from time t3 to time t4 illustrated in FIG. 6.

As illustrated in FIG. 13, at respective timings when one horizontal scanning period (1H) elapses from the respective starts of driving of the gate lines 13 in the areas 201A and 201C, the display control circuit 4 input data signals for the areas 201A and 201C to the terminal part 12s, and at the same time, supplies a voltage at the H level to the gate terminals of the switching elements SW1, while supplying a voltage at the L level to the gate terminals of the switching elements SW2. This causes the switching elements SW1 to be turned ON, and causes the switching elements SW2 to be turned OFF. As a result, the source lines 15a(j) become conductive with the terminal part 12s. Further, the source lines 15c(j) become conductive with the terminal part 12s through the source line portions 150d. This causes data signals for the areas 201A and 201C to be input to the source lines 15a(j) and the source lines 15c(j), respectively, from the terminal part 12s. During this period, since the source lines 15b(j) and 15d(j) in the areas 201B and 201D are not conductive, data signals for the areas 201A and 201C are not input to the source lines 15a(j) and 15c(j), respectively.

After the writing of data signals to the areas 201A and 201C ends, the display control circuit 4 inputs data signals for the areas 201B and 201D to the terminal part 12s, and at the same time, supplies a voltage at the L level to the gate terminals of the switching elements SW1, while supplying a voltage at the H level to the gate terminals of the switching elements SW2. This causes the switching elements SW1 to be turned OFF, and causes the switching elements SW2 to be turned ON, whereby the source lines 15b(j) become conductive with the terminal part 12s through the source line portions 150a. Further, the source lines 15d(j) become conductive with the terminal part 12s. As a result, data signals for the area 201B are input to the source lines 15b(j) from the terminal part 12s, and data signals for the area 201D are input to the source lines 15d(j) from the terminal part 12s. During this period, since the source lines 15a(j) and 15c(j) are not conductive, data signals for the areas 201A and 201C are not input to the source lines 15a(j) and 15c(j).

In Embodiment 3, by controlling ON/OFF of the switching elements SW1 and SW2, only the source lines in an area to which data signals are to be written are caused to be conductive with the terminal part 12s, so that the data signals are not input to the source lines in the other areas. Charging/discharging of the source lines 15 in areas where the writing of data signals is not performed is therefore made unnecessary, which makes it possible to reduce the power consumption for inputting data signals to the source lines 15.

### Embodiment 4

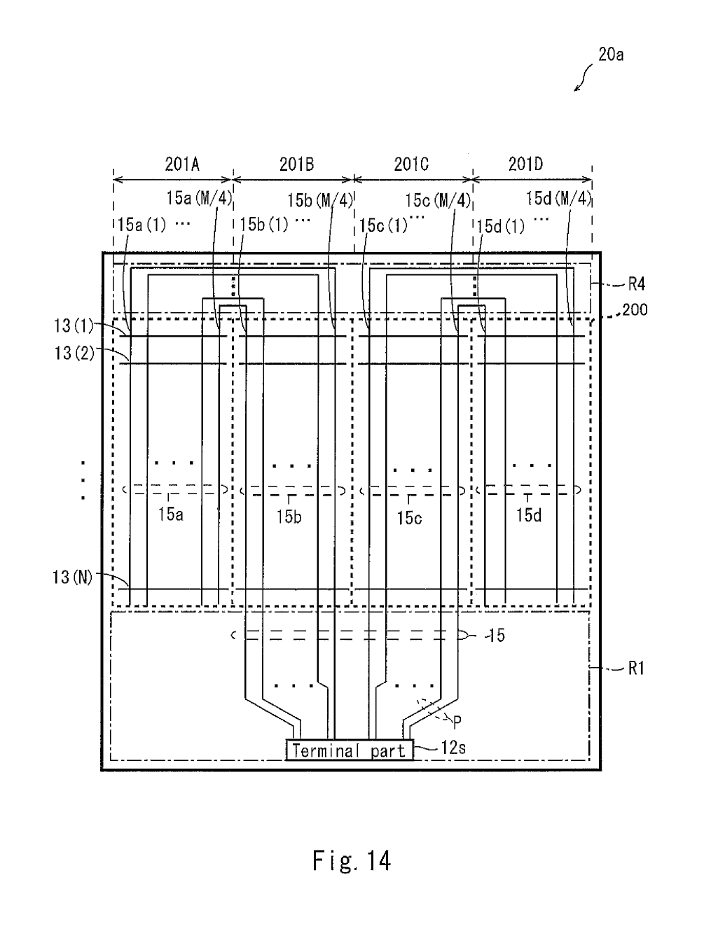

FIG. 14 is a schematic diagram illustrating an exemplary arrangement of the source lines 15 in the present embodiment. In the present embodiment, the exemplary arrangement of the source lines in the areas 201A to 201D is different from that in Embodiment 2 described above. The following description describes configurations different from those in Embodiment 2.

As illustrated in FIG. 14, the source lines 15 routed from the terminal part 12s to the area 201B pass through the frame region R4 (second frame region) opposed to the frame region R1, and are routed inside the area 201A. Further, the source lines 15 routed from the terminal part 12s to the area 201C pass through the frame region R4, and are routed inside the area 201D. In this example, the source lines 15 are formed in the same metal layer. In other words, in the present embodiment, the source lines 15a in the area 201A and the source lines 15b in the area 201B are connected, and the source lines 15c in the area 201C and the source lines 15d in the area 201D are connected.

The number of the source lines arranged in each area is M/4, as is the case with Embodiment 2. Besides, though the illustration is omitted in this drawing, in the area, the gate drivers 11 for driving the gate lines 13 are arranged in the area, and the terminal part 12g is arranged in the frame region R1.

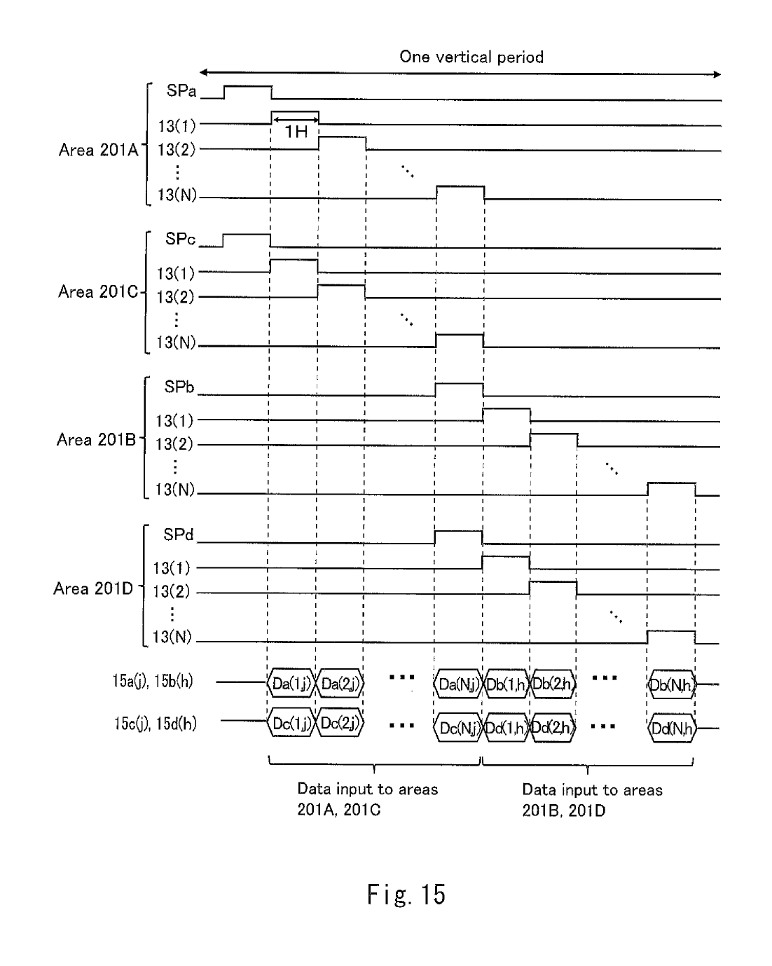

Next, the following description describes a data signal writing operation in the present embodiment. FIG. 15 illustrates a timing chart of a data signal writing operation in the present embodiment. As is the case with FIG. 7 mentioned above, the waveforms of the gate lines 13(1) to 13(N) in this diagram are waveforms during one horizontal scanning period (1H) that is latter one of two horizontal scanning periods (2H) when the gate lines 13 have a potential at the H level. In other words, the waveforms of the gate lines 13(n) in FIG. 15 are waveforms of the gate lines 13(n) during one horizontal scanning period from time t3 to time t4 illustrated in FIG. 6.

The present embodiment is identical to Embodiment 2 in the point that the writing of data signals to the areas 201B and 201D is performed after the writing of data signals in the areas 201A and 201C, but the present embodiment is different from Embodiment 2 in the following point.

As illustrated in FIG. 15, the gate lines 13 in the area 201A are sequentially driven, and at respective timings when one horizontal scanning period (1H) elapses from the respective starts of driving of the gate lines 13 in the area 201A, data signals Da(1, j) . . . Da(N, j) for the area 201A are input through the terminal part 12s to the source lines 15b(h) (h=M/4−j+1, j: integer, 1≦j≦M/4) in the area 201B. This causes the data signals Da(1, j) . . . Da(N, j) to be input to the source lines 15a(j) in the area 201A, whereby data signals are written in all of the pixels in the area 201A.

Likewise, the gate lines 13 in the area 201C are sequentially driven, and at respective timings when one horizontal scanning period (1H) elapses from the respective starts of driving of the gate lines 13 in the area 201C, data signals Dc(1, j) . . . Dc(N, j) for the area 201C are input through the terminal part 12s to the source lines 15c(j) in the area 201C, whereby data signals are written in all of the pixels in the area 201C.

Next, after the writing of data signals to the areas 201A and 201C, the gate lines 13 in the area 201B and the area 201D are driven sequentially. At respective timings when one horizontal scanning period (1H) elapses from the respective starts of driving of the gate lines 13 in the area 201B, data signals Db(1, h) . . . Db(N, h) for the area 201B are input through the terminal part 12s to the source lines 15b(h). Thereby, data signals are written in all of the pixels in the area 201B.

Likewise, the gate lines 13 in the area 201D are sequentially driven, and at respective timings when one horizontal scanning period (1H) elapses from the respective starts of driving of the gate lines 13 in the area 201D, data signals Dd(1, h) . . . Dd(N, h) for the area 201D are input through the terminal part 12s to the source lines 15d(h) in the area 201D, whereby data signals are written in all of the pixels in the area 201D.

Incidentally, in the present embodiment, as the set signal S for the gate driver 11(1) in the area 201B, the voltage of the gate line 13(N) in the area 201A may be input in place of the startpulse signal SPb. Further, as the set signal S for the gate driver (1) in the area 201D, the voltage of the gate line 13(N) in the area 201C may be input in place of the startpulse signal SPd. Alternatively, a common startpulse signal may be supplied to the gate drivers 11(1) in the areas 201A and 201C, and a common startpulse signal may be supplied to the gate drivers 11(1) in the areas 201C and 201D.

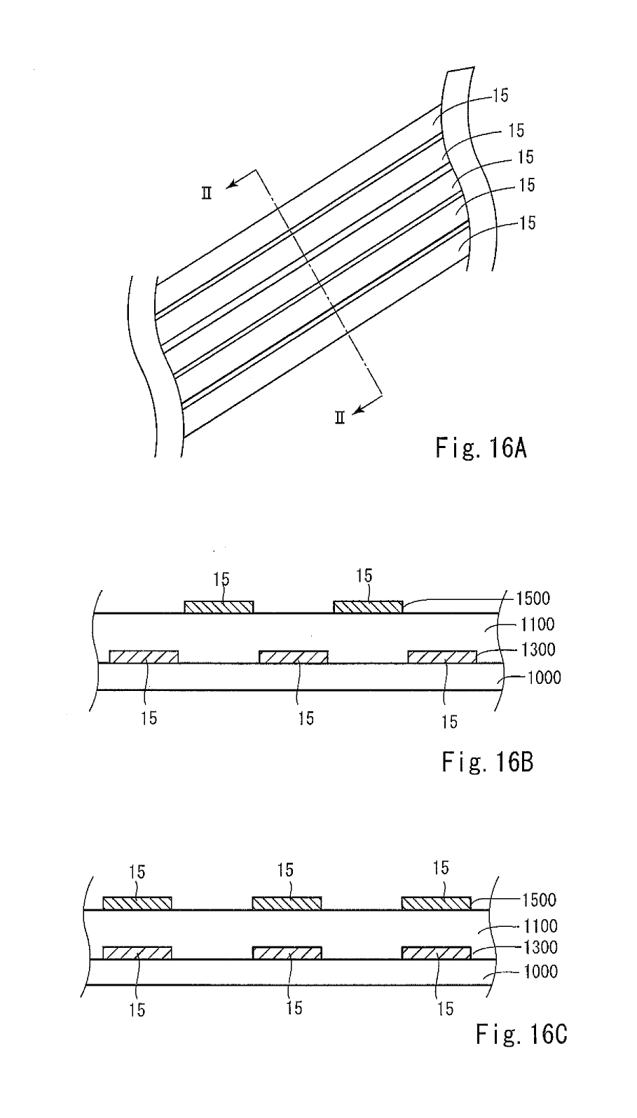

Each source line 15 may be formed in the same metal layer, or may be formed in the following manner. FIG. 16A is a schematic diagram illustrating parts of the source lines 15 in the broken line frame P illustrated in FIG. 14. FIG. 16B is a cross-sectional view taken along line II-II in the portions of the source lines 15 illustrated in FIG. 16A. As illustrated in FIGS. 16A and 16B, the source lines 15 are formed at uniform intervals in the first metal layer 1300 on the substrate 1000 that composes the active matrix substrate 20a. On an insulating film 1100 formed on the first metal layer 1300, a second metal layer 1500 is formed, and in the second metal layer 1500, source lines 15 are further formed at positions between the source line 15 and the source line 15 on the first metal layer 1300. In this way, in the frame region R1, the source lines 15 formed in the first metal layer 1300, and the source lines 15 formed in the second metal layer 1500 are alternately arranged.

The source lines 15 arranged in the areas 201A to 201D and the frame region R4 are formed in the second metal layer 1500. The source lines 15 formed in the first metal layer 1300, therefore, are connected with the source lines 15 arranged in the areas 201A to 201D, through the contact holes formed in the insulating film 1100.

In Embodiment 4, the source lines 15 do not intersect in the frame region R1. As illustrated in FIGS. 16A and 16B, therefore, the portions of the source lines 15 arranged in the frame region R1 are formed alternately in the first metal layer 1300 and the second metal layer 1500, whereby the source lines 15 arranged in the frame region R1 can be arranged at smaller intervals. As a result, as compared with the case where the portions of the source lines 15 arranged in the frame region R1 are formed in the same layer, the frame region R1 for routing the source lines 15 is allowed to have a smaller width L.

The example illustrated in FIG. 16B is an example in which the source lines 15 formed in the second metal layer 1500 and the source lines 15 formed in the first metal layer 1300 are arranged so as to be adjacent to each other in the horizontal direction of the active matrix substrate 20a, but the source lines 15 arranged in the frame region R1 may be configured as illustrated in FIG. 16C, for example. In other words, as illustrated in FIG. 16C, the source lines 15 formed in the second metal layer 1500 may be arranged so as to overlap the source lines 15 formed in the first metal layer 1300, with the insulating film 1100 being interposed therebetween.

### Embodiment 5

The present embodiment is different from Embodiment 2 regarding the configuration illustrated in FIG. 9 in which the source line portions 150d and the source lines 15c are connected. The following description describes the configuration different from that of Embodiment 2.

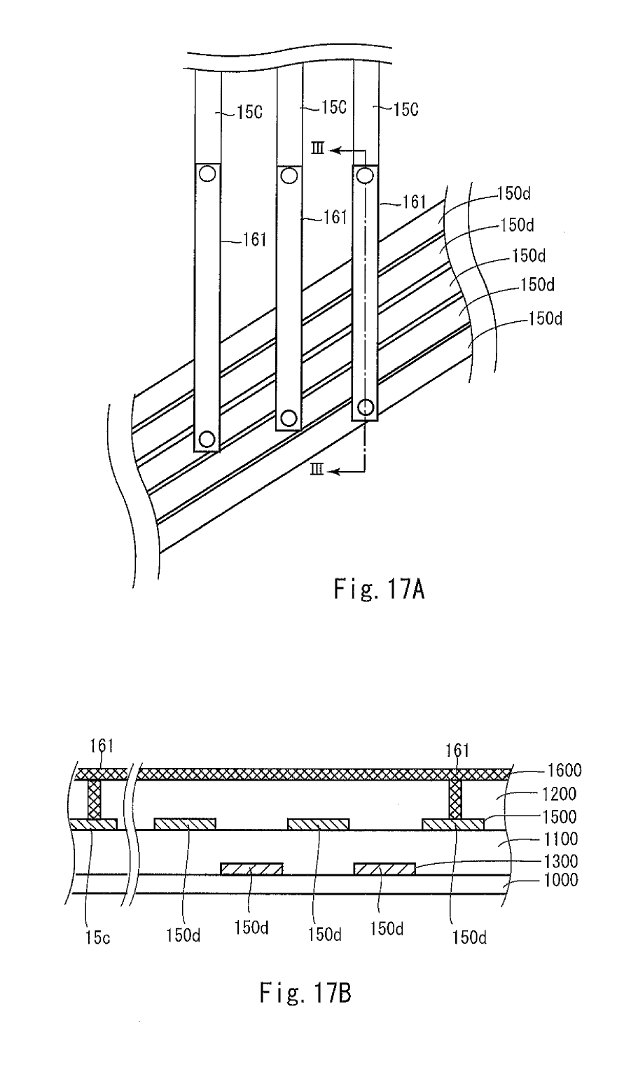

FIG. 17A is an enlarged schematic diagram illustrating a connection part where the source line portions 150d and the source lines 15c illustrated in FIG. 9 are connected. FIG. 17B is a cross-sectional view of the connection part of the source line portions 150d and the source lines 15c illustrated in FIG. 17A, the view being taken long line III-III.

As illustrated in FIG. 17A, the source line portions 150d are connected with connection lines 161, and are connected with the source lines 15c through the connection lines 161. More specifically, as illustrated in FIG. 17B, the source line portions 150d are formed at uniform intervals in the first metal layer 1300 on the substrate 1000, and the insulating film 1100 is formed so as to cover the source line portions 150d. In the second metal layer 1500 on the insulating film 1100, the source line portions 150d are formed at positions between the source line portions 150d formed in the first metal layer 1300. Then, the insulating film 1200 is formed so as to cover the source line portions 150d formed in the second metal layer 1500, and the connection lines 161 are formed in a third metal layer 1600 on the insulating film 1200. The connection lines 161 are connected with the source line portions 150d and the source lines 15c formed in the second metal layer 1500, through contact holes provided in the insulating film 1200.

Though illustration is omitted, the source line portions 150d formed in the first metal layer 1300 are connected with the connection lines 161 through the contact holes provided in the insulating film 1200 and the insulating film 1100. Further, the source line portions 150d formed in the first metal layer 1300 are connected with the source lines 15d in the area 201D, through the contact holes provided in the insulating films 1200 and 1100.

The example described above is referred to when the structure of connection of the source line portions 150d and the source lines 15c is described, and the structure of connection of the source lines 15b in the area 201B and the source line portions 150a in the frame region R1 is identical to the above-described structure of connection.

In Embodiment 5 described above, the source line portions in one area in the frame region R1 are alternately formed in the first metal layer 1300 and the second metal layer 1500, and the source line portions and the source lines 15 in the other areas are connected through the connection lines 161 formed in the third metal layer 1600. As compared with a case where all of the source line portions in the frame region R1 are formed in the same layer, the source line portions can be arrange at smaller intervals, whereby the frame region R1 for routing the source lines is allowed to have a smaller width L as compared with Embodiment 2.

### Embodiment 6

Embodiment 2 is described with reference to an exemplary case where the pixels corresponding to R, G, and B of the color filters are arrayed in the order of R, G, B along the gate line 13 extending direction. The present embodiment is described with reference to an exemplary case where the pixels corresponding to R, G, and B of the color filters are arrayed in the order of R, G, B along the source line 15 extending direction.

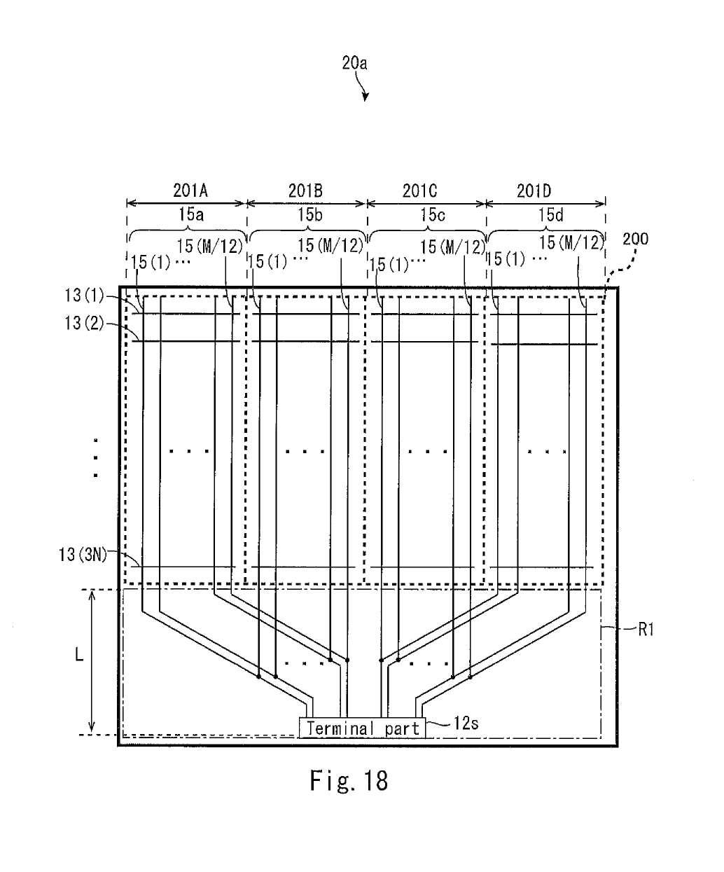

FIG. 18 is a schematic diagram illustrating a schematic configuration of the active matrix substrate 20a in the present embodiment. As illustrated in FIG. 18, each of the areas 201A to 201D of the active matrix substrate 20a, 3N gate lines 13 (13(1) to 13(3N)), and M/12 source lines 15(1) to 15(M/12) are arranged. In other words, each of the areas 201A to 201D in the present embodiment includes the gate lines 13 the number of which is three times the number thereof in Embodiment 2, and the source lines 15 the number of which is ⅓ of the number thereof in Embodiment 2. Though illustration is omitted in FIG. 18, in the pixels in each area, gate drivers 11 for diving the gate lines 13 in the area are provided, and a terminal part 12g is provided in the frame region R1.

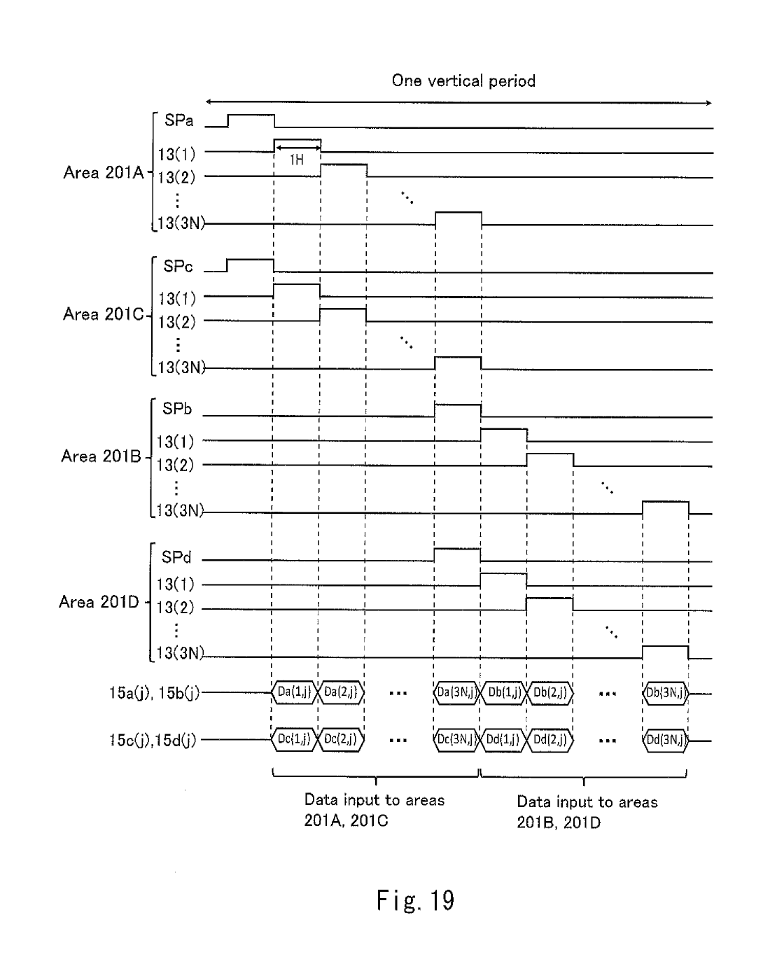

FIG. 19 illustrates a timing chart of a data signal writing operation in the present embodiment. As is the case with FIG. 7 mentioned above, the waveforms of the gate lines 13(1) to 13(N) in this diagram are waveforms during one horizontal scanning period (1H) that is latter one of two horizontal scanning periods (2H) when the gate lines 13 have a potential at the H level. In other words, the waveforms of the gate lines 13(n) in FIG. 19 are waveforms of the gate lines 13(n) during one horizontal scanning period from time t3 to time t4 illustrated in FIG. 6. In the present embodiment as well, as is the case with Embodiment 2, after the writing of data signals in the areas 201A and 201C is performed, the gate lines 13 in the areas 201B and 201D are driven, and data signals are written in the pixels in the areas 201B and 201D.

The timing chart illustrated in FIG. 19 is different from the timing chart in Embodiment 2 illustrated in FIG. 10 in the following point: 3N gate lines 13(1) to 13(3N) are sequentially driven in each area, and data signals for the pixels in the first to 3K-th rows in the foregoing area are supplied to the source lines 15 in the foregoing area at the timings when the gate lines 13(1) to 13(3N) are sequentially driven.

For example, the gate lines 13(1) to 13(3N) in the area 201A are sequentially driven, and at respective timings when one horizontal scanning period (1H) elapses from the respective starts of driving of the gate lines 13(1) to 13(3N) in the area 201A, the display control circuit 4 supplies, to the terminal part 12s, data signals Da(1, j) . . . Da(3N, j) for the pixels in the first to 3N-th rows in the area 201A. In the present embodiment, however, “j” satisfies 1≦j≦M/12. This allows data signals Da(1, j) . . . Da(3N, j) to be input to the source lines 15(1) to 15(M/12) in the area 201A, whereby data signals are written in all of the pixels in the area 201A. The data signal writing operations with respect to the other areas 201B to 201D are identical to the data signal writing operation with respect to the area 201A.

While the number of the source lines 15 routed from the terminal part 12s to the frame region R1 is M/2 In Embodiment 2 described above, the number of the same is M/6 in Embodiment 6 described above. In Embodiment 6, therefore, the width L for routing the source lines 15 from the terminal part 12s to the frame region R1 can be further reduced, as compared with Embodiment 2.

### Embodiment 7

The description of the present embodiment describes an exemplary case where data signal writing with respect to specific pixels in a part of areas in Embodiment 2 is performed at a frame frequency of, for example, 60 Hz, and data signal writing with respect to the other pixels is performed at a frame frequency of, for example, 1 Hz.

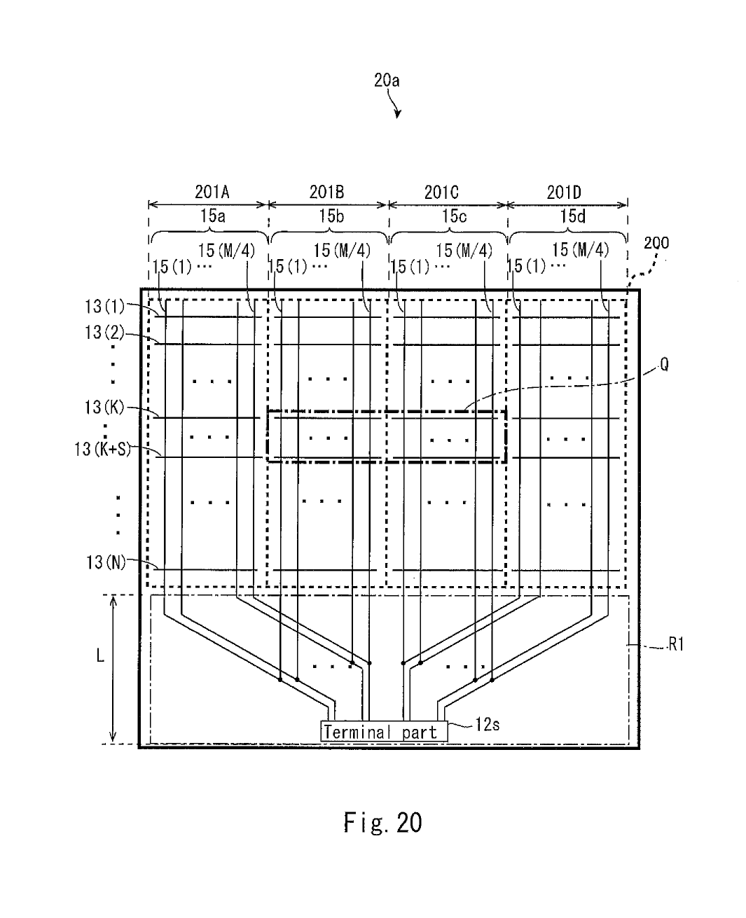

FIG. 20 is a schematic diagram illustrating a schematic configuration of an active matrix substrate 20a in the present embodiment. On the active matrix substrate 20a illustrated in FIG. 20, as is the case with the configuration illustrated in FIG. 9, N gate lines 13(1) to 13(N) are provided in each of the areas 201A to 201D, and M/2 source lines 15 are routed from the terminal part 12s.

In the present embodiment, data signal writing with respect to a part of pixels in the areas 201B and 201C in a dashed dotted line frame Q in FIG. 20 is performed at a frame frequency of 60 Hz, data signal writing with respect to the other pixels is performed at a frame frequency of 1 Hz.

Though illustration is omitted in FIG. 20, gate drivers for driving the gate lines 13 in each area are arranged in the pixels in the area, and a terminal part 12g is arranged in the frame region R1.

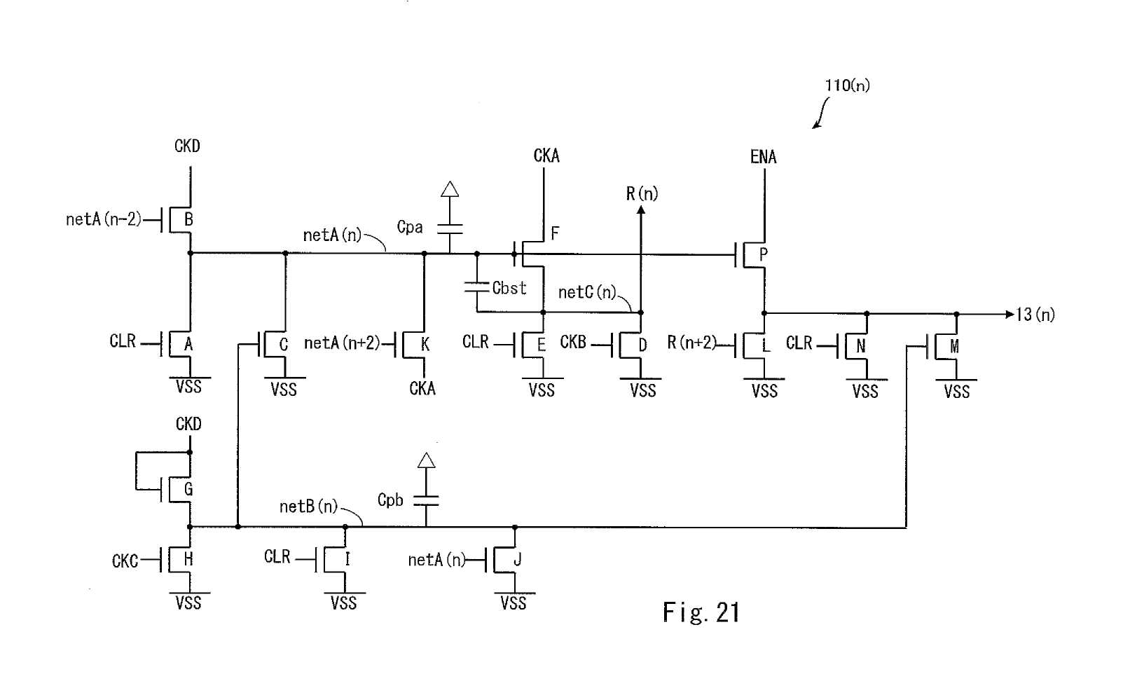

FIG. 21 illustrates an equivalent circuit of the gate driver in the present embodiment. The configuration of the gate driver 110 in the present embodiment is different from the configuration of the gate driver 11 in Embodiment 2 in the following point.

The gate driver 110(n) includes TFTs-A to -M, and TFT-P, as well as internal lines netA(n), netB(n), and netC(n).

To netA(n) in the gate driver 110(n), the source terminal of TFT-B, the drain terminals of TFT-A, TFT-C, and TFT-K, the gate terminals of TFT-F and TFT-P, and one of electrodes of the capacitor Cbst are connected.

To netB(n), the source terminal of TFT-G, the drain terminals of TFT-H, TFT-I, and TFT-J, and the gate terminals of TFT-C and TFT-M are connected.

To netC(n), the source terminal of TFT-F, the capacitor Cbst, the drain terminal of TFT-E, and the drain terminal of TFT-D are connected. The voltage R(n) of netC(n) is input to the gate terminal of TFT-L of the gate driver 110(n−2) for driving the gate line 13(n−2).

Regarding TFT-F, the gate terminal thereof is connected with netA(n), the clock signal CKA is supplied to the drain terminal thereof, and the source terminal thereof is connected to netC(n).

Regarding TFT-E, the reset signal CLR is supplied to the gate terminal thereof, the drain terminal thereof is connected to netC(n), and the power source voltage signal VSS is supplied to the source terminal thereof.

Regarding TFT-D, the clock signal CKB is supplied to the gate terminal thereof, the drain terminal thereof is connected to netC(n), and the power source voltage signal VSS is supplied to the source terminal thereof.

Regarding TFT-L, the gate terminal thereof is connected with netC(n+2) in the gate driver 110(n+2) for driving the gate line 13(n+2), the drain terminal thereof is connected with the gate line 13(n), and the power source voltage signal VSS is supplied to the source terminal thereof.

Regarding TFT-N, the reset signal CLR is supplied to the gate terminal thereof, the drain terminal thereof is connected with the gate line 13(n), and the power source voltage signal VSS is supplied to the source terminal thereof.

Regarding TFT-M, the gate terminal thereof is connected with netB(n), the drain terminal thereof is connected with the gate line 13(n), and the power source voltage signal VSS is supplied to the source terminal thereof.

Regarding TFT-P, the gate terminal thereof is connected with netA(n), a row selection signal ENA to be described below is supplied to the drain terminal thereof, and the source terminal thereof is connected with the gate line 13(n).

Regarding TFT-K, the gate terminal thereof is connected with netA(n+2), the clock signal CKA is supplied to the drain terminal thereof, and the source terminal thereof is connected with netA(n).

Regarding TFT-J, the gate terminal thereof is connected with netA(n), the drain terminal thereof is connected with netB(n), and the power source voltage signal VSS is supplied to the source terminal thereof.

In Embodiment 2, to the gate terminal of the TFT-J, the adjacent gate line 13(n−1) is connected, but in the present embodiment, the adjacent the gate line 13(n−1) is not driven in some cases. In the present embodiment, therefore, the configuration is such that the voltage of the adjacent gate line 13 should not be input to the gate driver 110(n).

The row selection signal is a signal that exhibits a potential at the H level (VDD) or the L level (VSS). The display control circuit 4 supplies, as control signals, any one of row selection signals ENA, ENB, ENC, and END in addition to the clock signals, to the drain terminal of TFT-P in each gate driver 110.

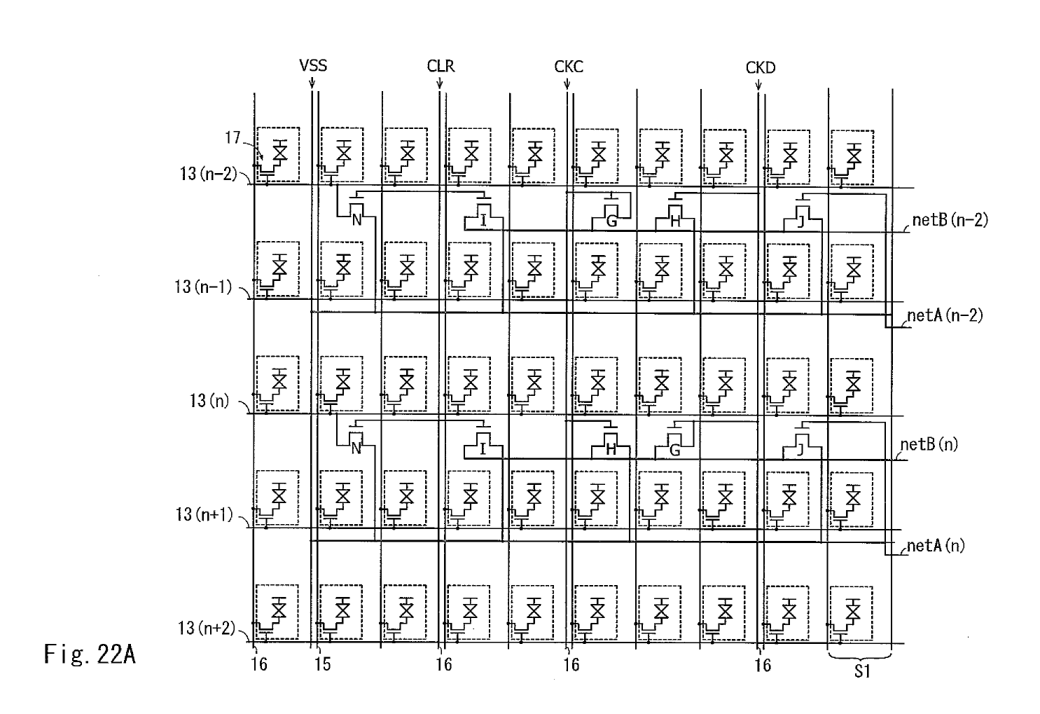

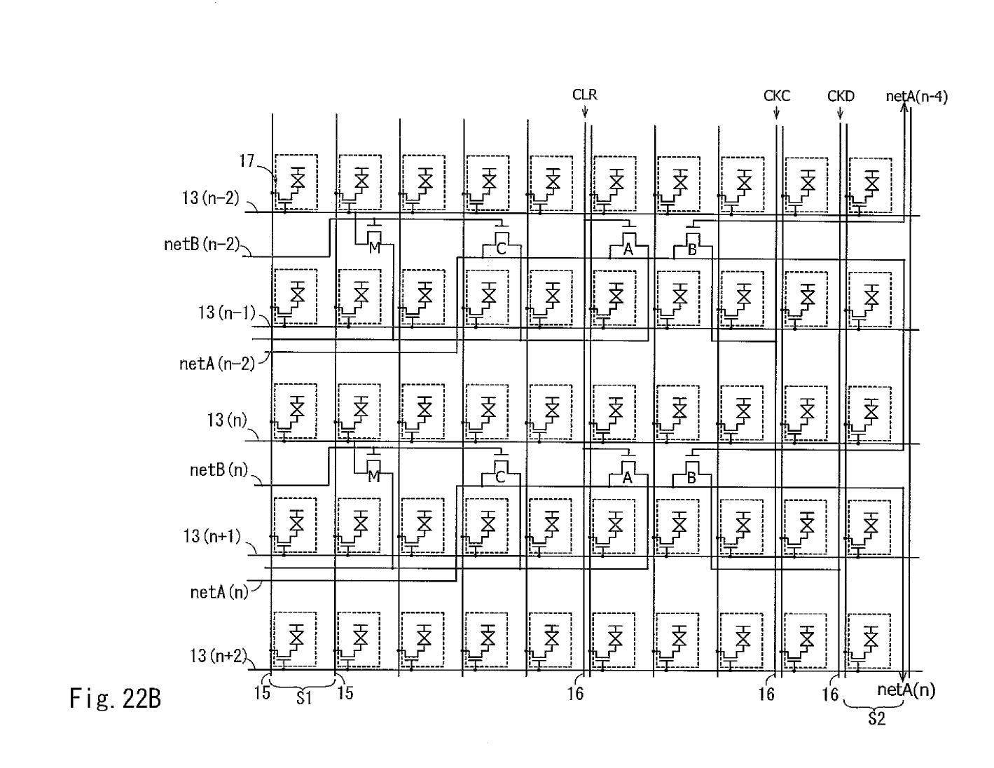

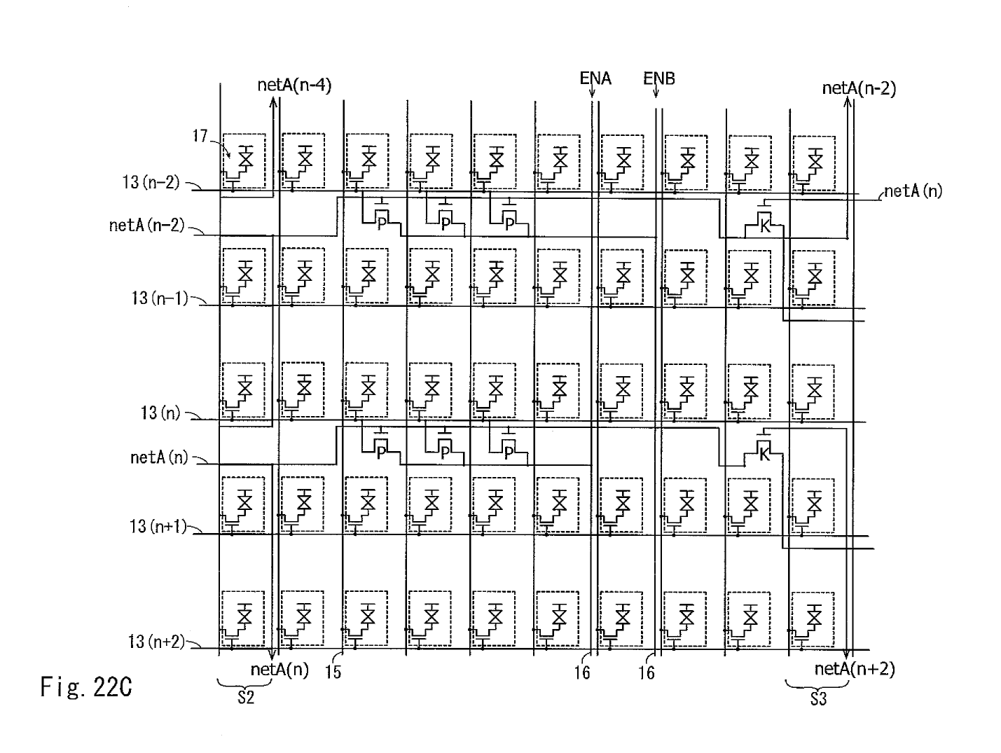

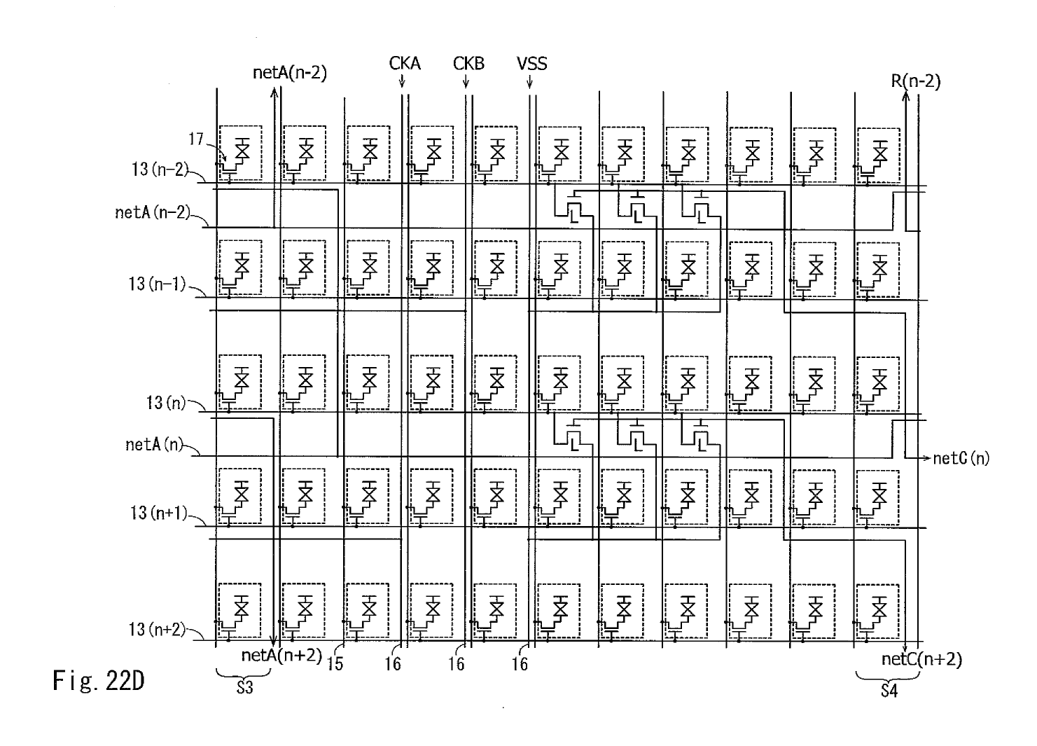

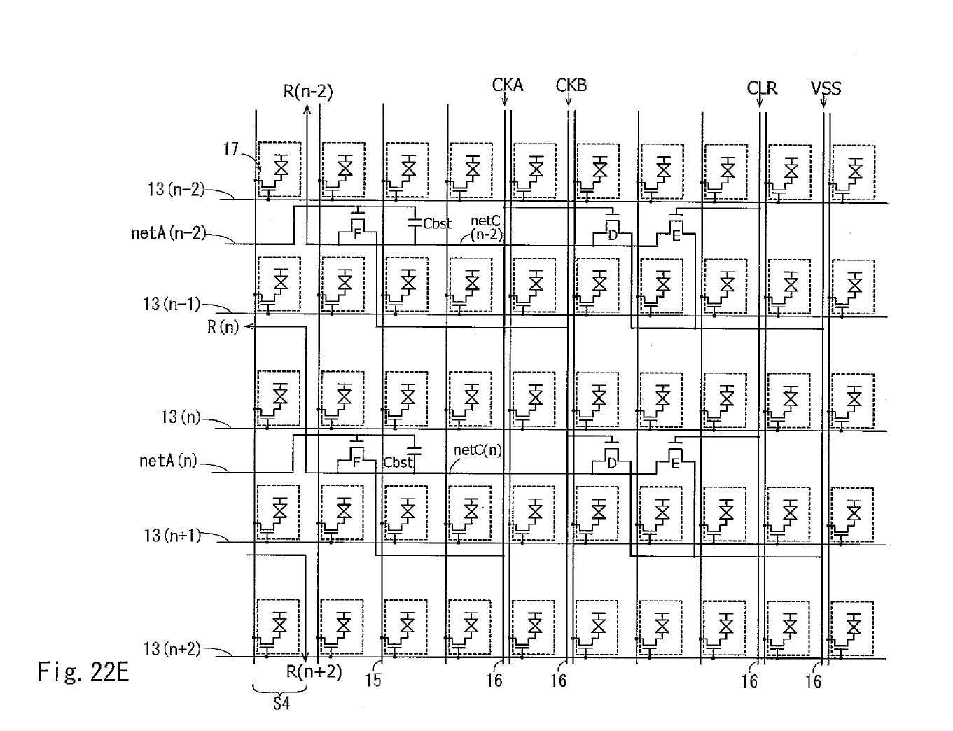

Next, the following description describes an arrangement layout of elements that compose the gate driver 110, while referring to FIGS. 22A to 22E. FIGS. 22A to 22E are schematic diagram illustrating an exemplary arrangement of elements in the gate driver 110(n), and the gate driver 110(n−2) for driving the gate line 13(n−2).

Though the description of “TFT-” is omitted in FIGS. 22A to 22E for convenience sake, TFTs denoted by alphabetic characters in each drawing corresponding to TFTs denoted by the same alphabetic characters in FIG. 21. FIGS. 22A and 22B are continuous to each other at the column S1 in each drawing, and FIGS. 22B and 22C are continuous to each other at the column S2 in each drawing. Further, FIGS. 22C and 22D are continuous at the column S3 in each drawing, and FIGS. 22D and 22E are continuous to each other at the column S4 in each drawing.

As illustrated in FIGS. 22A to 22E, TFTs-A to -M, TFT-P, netA(n), netB(n), and netC(n) of the gate driver 110(n) are arranged in a space between the gate line 13(n) and the gate line 13(n+2). Further, TFTs-A to -M, TFT-P, netA(n−2), netB(n−2), and netC(n−2) of the gate driver 110(n−2) are arranged in a space between the gate line 13(n−2) to the gate line 13(n).

As illustrated in FIG. 22C, TFT-P is formed with three TFTs-P that are connected in parallel. Though TFT-P is formed with three TFTs connected in parallel in this example, the number of TFTs is not limited to this. The drain terminal of each TFT-P in the gate driver 110(n) is connected to the control line 16 to which the row selection signal ENA is supplied. On the other hand, the drain terminal of each TFT-P in the gate driver 110(n−2) is connected with the control line 16 to which the row selection signal ENB is supplied.

Though illustration is omitted, the drain terminal of TFT-P in the gate driver 110(n−1) for driving the gate line 13(n−1) is connected with the control line 16 to which the row selection signal END is supplied. Further, the drain terminal of TFT-P in the gate driver 110(n+1) for driving the gate line 13(n+1) is connected with the control line 16 to which the row selection signal ENC is supplied. Further, the drain terminal of each TFT-P in the gate driver 110(n+2) for driving the gate line 13(n+2) is connected with the control line 16 to which the row selection signal ENB is supplied.

Further, as illustrated in FIG. 22D, TFT-L is formed with three TFTs-L connected in parallel. Though TFT-L is formed with three TFTs connected in parallel in this example, the number of TFTs is not limited to this. The gate terminal of each TFT-L in the gate driver 110(n) is connected with netC(n+2) in the gate driver 110(n+2), and the voltage R(n+2) of netC(n+2) is input thereto. The gate terminal of each TFT-L in the gate driver 110(n−2) is connected with netC(n), and the potential R(n) of netC(n) is input thereto. In FIG. 22D, the control line 16 to which the direct current voltage signal at the L level (VSS) is supplied is connected with the source terminal of each TFT-L in the gate driver 110(n) and the gate driver 110(n−2).

In FIG. 22E, netC(n) in the gate driver 110(n) is connected to the gate terminal of TFT-L in the gate driver 110(n−2) illustrated in FIG. 22D. Further, netC(n−2) in the gate driver 110(n−2) is connected to the gate terminal of TFT-L in the gate driver 110(n−4), which is not illustrated.

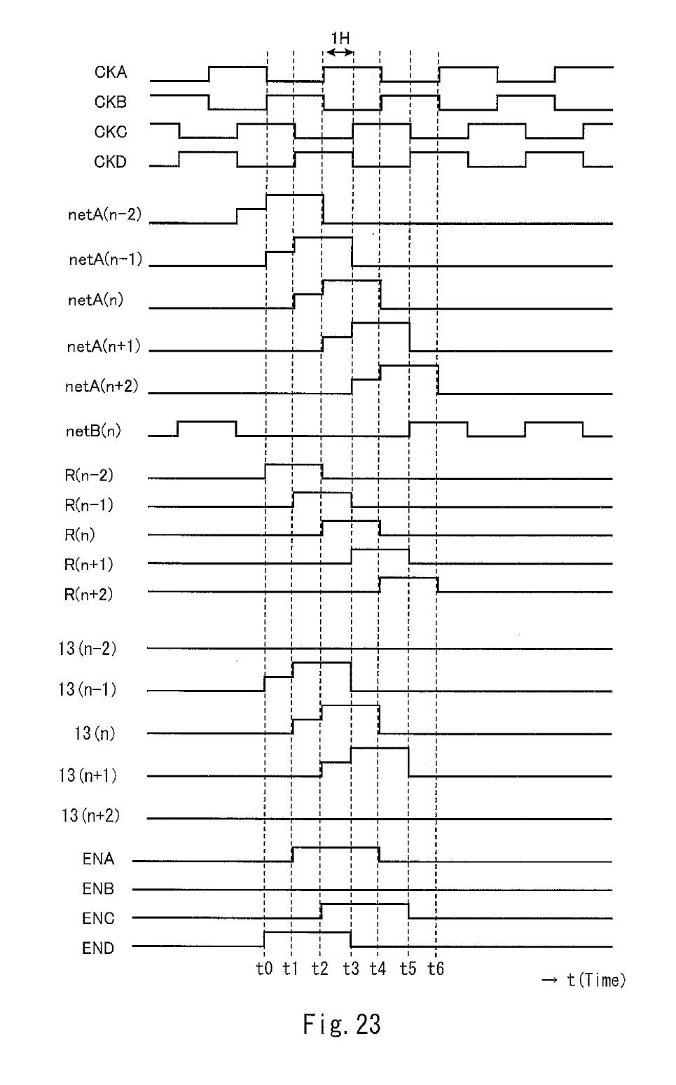

Next, the following description describes operations of the gate driver 110(n) in the present embodiment. FIG. 23 illustrates a timing chart in a case where arbitrary gate lines 13 (13(n−1) to 13(n+1)) in one area is driven in one frame, and the driving of other gate lines 13 (13(n−2), 13(n+2)) is stopped.

The display control circuit 4 supplies row selection signals END, ENA, and ENC of a voltage at the H level to the gate driver 110(n−1), the gate driver 110(n), and the gate driver 110(n+1) at the timings when the potentials of netA(n−1), netA(n), netA(n+1) rise to the H level. Further, the display control circuit 4 supplies the row selection signal ENB that has a L level voltage during one frame to the gate driver 110(n−2) and the gate driver 110(n+2).

Referring to FIGS. 21 and 23, the clock signals CKD and the potential of netA(n−2) are at the H level at time t1. At time t1, therefore, TFT-B of the gate driver 110(n) is in the ON state, and the potential at the H level (VDD) of the clock signal CKD is precharged through TFT-B to netA(n). This causes TFT-P of the gate driver 110(n) to be turned ON. At time t1, since the potential of the row selection signal ENA is at the H level, the gate line 13(n) is charged to the potential of (VDD minus the threshold voltage of TFT-P) through TFT-P. Further, here, TFT-F is also turned ON, but since the potential of the clock signal CKA is at the L level, the potential R(n) of netC(n) is maintained at the L level.

At time t2, the potential of the clock signal CKA rises to the H level. Since TFT-F of the gate driver 110(n) is in the ON state, a voltage at the H level of the clock signal CKA is input to netC(n) through TFT-F. As the potential of netC(n) rises, the potential of netA(n) is boosted through the capacitor Cbst, and is charged to the potential greater than (VDD plus the threshold voltage of TFT-P) (hereinafter referred to as “main charge”). Here, since TFT-P of the gate driver 110(n) is in the ON state and the potential of the row selection signal ENA is at the H level, a voltage at the H level is input to the gate line 13(n), whereby the gate line 13(n) shifts to the selected state.

At time t3, the potential of the clock signal CKA is at the H level, netA(n) maintains the potential at the H level, and TFT-F and TFT-P are in the ON state. The gate line 13(n) therefore remains in the selected state.

From time t4 to time t5, the potentials of the clock signal CKA and the row selection signal ENA fall to the L level, the potential of the clock signal CKB rises to the H level, netA(n+2) in the gate driver 110(n+2) is subjected to main charge, and the potential R(n+2) of netC(n+2) rises to the H level. This causes TFT-K and TFT-L in the gate driver 110(n) to be turned ON. As a result, the potential of netA(n) is pulled down to the L level (VSS) through TFT-K, and the voltage at the L level (VSS) is applied through TFT-L to the gate line 13(n). Here, TFT-P of the gate driver 110(n+2) is in the ON state, but since the potential of the row selection signal ENB is at the L level, the potential of the gate line 13(n+2) remains at the L level.

After time t6, since the potential R(n+2) of netC(n+2) and netA(n+2) fall to the L level, TFT-K and TFT-L of the gate driver 110(n) are turned OFF, but at the timing when the potential of the clock signal CKD rises to the H level, a voltage at the H level is input to netB(n), whereby TFT-C and TFT-M are turned ON. NetA(n) is maintained at the potential at the L level through TFT-C, and the gate line 13(n) is maintained at the potential at the L level through TFT-M.

The gate driver 110(n−2), the gate driver 110(n−1), and the gate driver 110(n+1) are driven in the same manner as the gate driver 110(n). In other words, from time t0 to time t2, netA(n−2) in the gate driver 110(n−2) is subjected to main charge as the potential R(n−2) of netC(n−2) rises, but since the potential of the row selection signal ENB is at L level, the potential of the gate line 13(n−2) remains at the L level. From time t1 to t3, netA(n−1) of the gate driver 110(n−1) is subjected to main charge as the potential R(n−1) of netC(n−1) rises. Here, since the potential of the row selection signal END is at the H level, the gate line 13(n−1) shifts to the selected state. From time t3 to time t5, netA(n+1) in the gate driver 110(n+1) is subjected to main charge as the potential R(n+1) of netC(n+1) rises. Here, since the potential of the row selection signal ENC is at the H level, the gate line 13(n+1) shifts to the selected state.

In this way, the row selection signal of a voltage at the H level is supplied to the gate driver 110 corresponding to the gate line 13 to be driven, during a period while the gate line 13 is to be driven, and the row selection signal of a voltage at the L level is supplied to the gate driver 110 corresponding to the gate line 13 not to be driven, during a period of one frame. This makes it possible to drive only arbitrary gate lines 13 during one frame period.

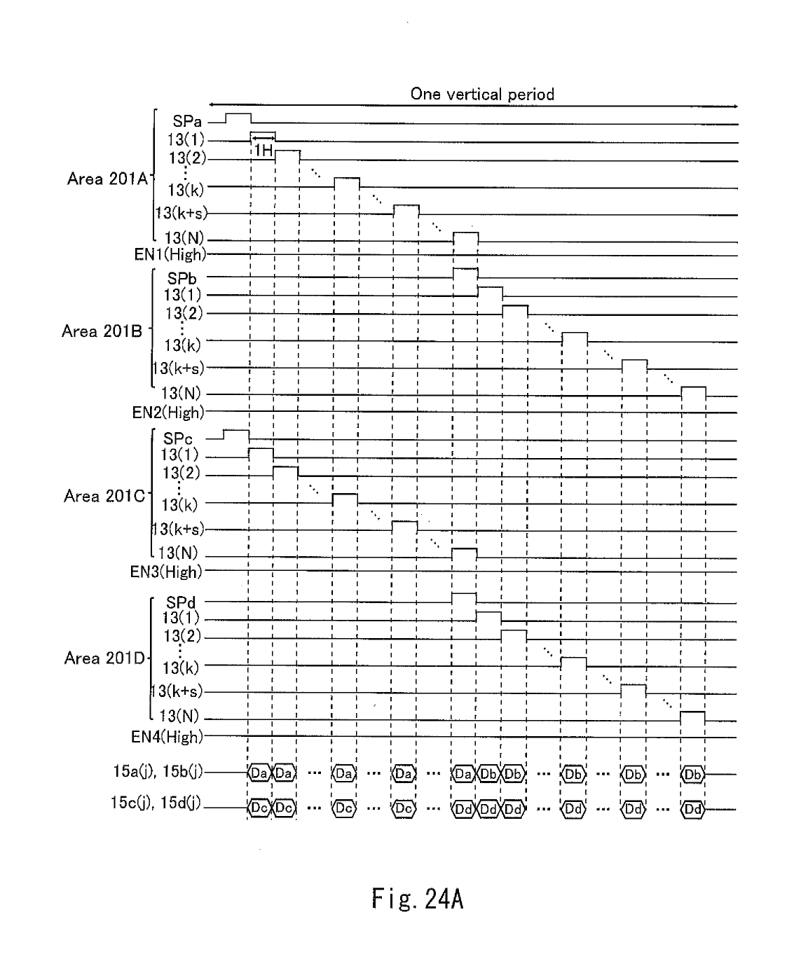

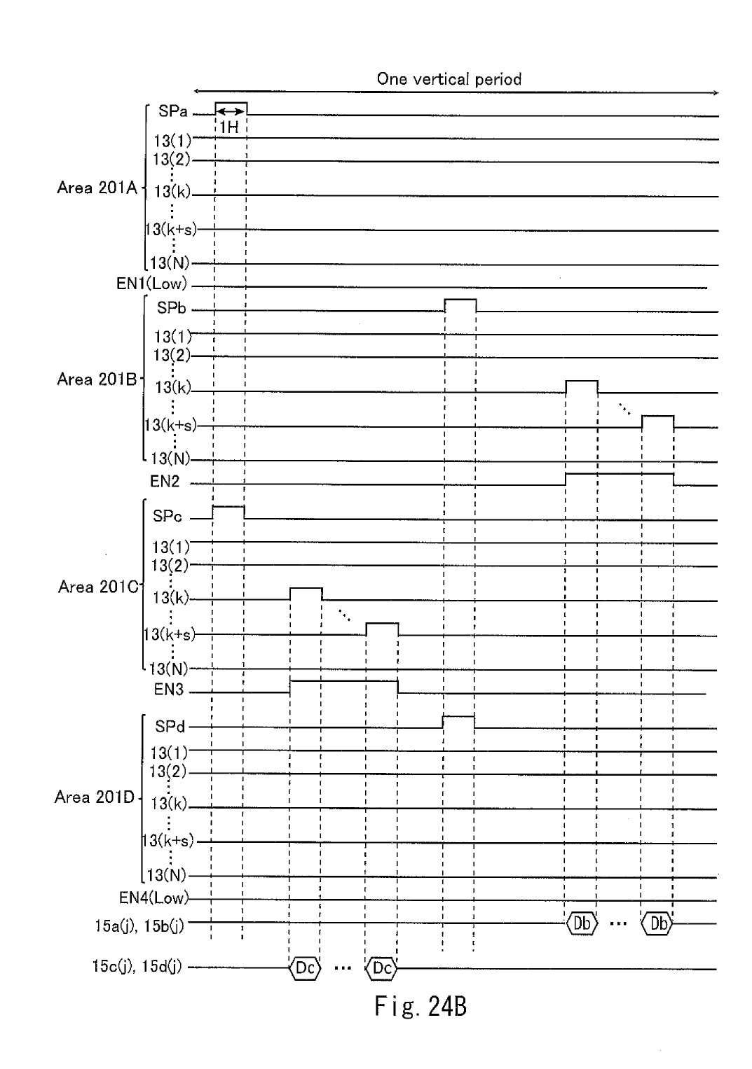

Next, the following description describes the data signal writing operation in the present embodiment. FIG. 24A is a timing chart of a data signal writing operation with respect to the first frame among sixty frames. As is the case with FIG. 7 mentioned above, the waveforms of the gate lines 13(1) to 13(N) in this diagram are waveforms during one horizontal scanning period (1H) that is latter one of two horizontal scanning periods (2H) when the gate lines 13 have a potential at the H level. In other words, the waveforms of the gate lines 13(n) in FIG. 24A are waveforms of the gate lines 13(n) during one horizontal scanning period from time t3 to time t4 illustrated in FIG. 6. Further, in FIG. 24A, for convenience sake, the row selection signals (ENA to END) supplied to the gate drivers 110 in the areas 201A and 201B, 201C, and 201D are referred to generally as EN1, EN2, EN3, and EN4, respectively.

In the present embodiment, regarding the first frame, as is the case with Embodiment 2 described above, all of the gate lines 13 in the areas 201A and 201C are sequentially driven so that data signal writing is performed with respect to the areas 201A and 201C, and thereafter, all of the gate lines 13 in the areas 201B and 201D are sequentially driven so that data signal writing is performed with respect to the areas 201B and 201D.

With respect to the first frame, the display control circuit 4 starts supplying the clock signals CKA to CKD to the gate drivers 110 in the area 201A to 201D, and as illustrated in FIG. 24A, supplies row selection signals EN1 to EN4 of a voltage at the H level. This causes all of the gate lines 13 in the areas 201A and 201C to be sequentially driven, and at respective timings when one horizontal scanning period (1H) elapses from the respective starts of driving of the gate lines 13 in the areas 201A and 201C, the data signals Da (Da(1, j) . . . Da(N, j)) for the area 201A, and the data signals Dc ((Dc(1, j) . . . Dc(N, j)) for the area 201C, are supplied to the source lines 15a(j) and the source lines 15c(j), respectively. As a result, data signals are written in all of the pixels in the areas 201A and 201C.

After the writing of data signals in the areas 201A and 201C, startpulse signals SPb and SPd are supplied from the display control circuit 4 to the gate drivers 110(1) in the areas 201B and 201D, whereby all of the gate line 13 in the areas 201A and 201C are sequentially driven. At respective timings when one horizontal scanning period (1H) elapses from the respective starts of driving of the gate lines 13 in the areas 201B and 201D, data signals Db (Db(1, j) . . . Db(N, j)) for the area 201B and, data signal Dd (Dd(1, j) . . . Dd(N, j)) for the area 201D are supplied to the source lines 15b(j) and the source lines 15d(j), respectively. As a result, data signals are written in all of the pixels in the areas 201B and 201D.

The following description describes the data signal writing operation with respect to the second to sixtieth frames. FIG. 24B is a timing chart of a data signal writing operation in each frame period with respect to the second to sixtieth frames. In this drawing as well, as is the case with FIG. 24A, the waveforms of the gate lines 13(1) to 13(N) in this diagram are waveforms during one horizontal scanning period (1H) that is latter one of two horizontal scanning periods (2H) when the gate lines 13 have a potential at the H level.

In the dashed dotted line frame Q illustrated in FIG. 20, which is arranged in the areas 201B and 201C, (s+1) gate lines 13, i.e., gate lines 13(k) to 13(k+s) (k, s: integers, 1≦k<N, 1≦s<N−2) are arranged. In this example, the gate lines 13(k) to 13(k+s) arranged in the areas 201B and 201C are driven at 60 Hz, and the other gate lines 13 are driven at 1 Hz.

As illustrated in FIG. 24B, the display control circuit 4 supplies startpulse signals SPa and SPc to the gate drivers 110(1) in the areas 201A and 201C at the start of each frame, supplies the row selection signal EN1 having a potential at the L level to the gate drivers 110 in the area 201A in each frame period, and does not supply data signals to the source lines 15a(j) in the area 201A.

Further, as FIG. 24B, the display control circuit 4 supplies the row selection signal EN3 having a potential at the H level to the gate drivers 110 in the area 201C during each frame period, at timings of driving the gate lines 13(k) to 13(k+s) in the area 201C. Further, the display control circuit 4 supplies, to the source lines 15d(j), data signals Dc (Dc(k, j) . . . Dc(k+s, j) for respective pixels that are formed by the gate lines 13(k) to 13(k+s), at respective timings when one horizontal scanning period (1H) elapses from the respective starts of driving of the gate lines 13(k) to 13(k+s).

This causes all of the gate lines 13 in the area 201A to have a potential at the L level in each frame period of the second to sixtieth frames, whereby data signals are written in none of the pixels in the area 201A. Further, in the area 201C, the gate lines 13 except for the gate lines 13(k) to 13(k+s) have a potential at the L level, whereby only the gate lines 13(k) to 13(k+s) are driven. As a result, the data signals Dc are input through the source lines 15d(j) to the source lines 15c(j), whereby data signals are written in the respective pixels formed by the gate lines 13(k) to 13(k+s) in the area 201C.

After the data signal writing in the area 201C, as illustrated in FIG. 24B, the display control circuit 4 supplies the startpulse signals SPb and SPd to the gate drivers 110(1) in the areas 201B and 201D, supplies the row selection signal EN4 having a voltage at the L level to the gate drivers 110 in the area 201D, and does not supply data signals to the source lines 15d(j) in the area 201D.

Further, as illustrated in FIG. 24B, the display control circuit 4 supplies the row selection signal EN2 having a voltage at the H level to the gate drivers 110 in the area 201B at timings of driving the gate lines 13(k) to 13(k+s) in the area 201B. Further, the display control circuit 4 supplies, to the source lines 15a(j), data signals Db (Db(k, j) . . . Db(k+s, j) for respective pixels that are formed by the gate lines 13(k) to 13(k+s) in the area 201B, at respective timings when one horizontal scanning period (1H) elapses from the respective starts of driving of the gate lines 13(k) to 13(k+s).

This causes all of the gate lines 13 in the area 201D to have a potential at the L level in each frame period of the second to sixtieth frames, whereby data signals are written in none of the pixels in the area 201D. Further, in the area 201B, the gate lines 13 except for the gate lines 13(k) to 13(k+s) have a potential at the L level, whereby only the gate lines 13(k) to 13(k+s) are driven. As a result, the data signals Db are input through the source lines 15a(j) to the source lines 15b(j), whereby data signals of each frame are written in the respective pixels formed by the gate lines 13(k) to 13(k+s) in the area 201B.

In this way, in Embodiment 7 described above, arbitrary gate lines 13 can be driven with a certain frame frequency, and the other gate lines 13 can be driven with a frame frequency lower than the foregoing frame frequency. This makes it possible to, for example, drive the gate lines 13 for the pixels displaying a still image with a low frame frequency (for example 1 Hz), and drive the gate lines 13 for the pixels displaying a moving image with a high frame frequency (for example, 60 Hz), whereby the electric power consumption needed for the data signal writing operation can be reduced.

### Embodiment 8

Embodiments 1 to 7 described above are described with reference to an exemplary case where the active matrix substrate 20a includes the display region 200 in an approximately rectangular shape, but the shape of the display region is limited to the rectangular shape.

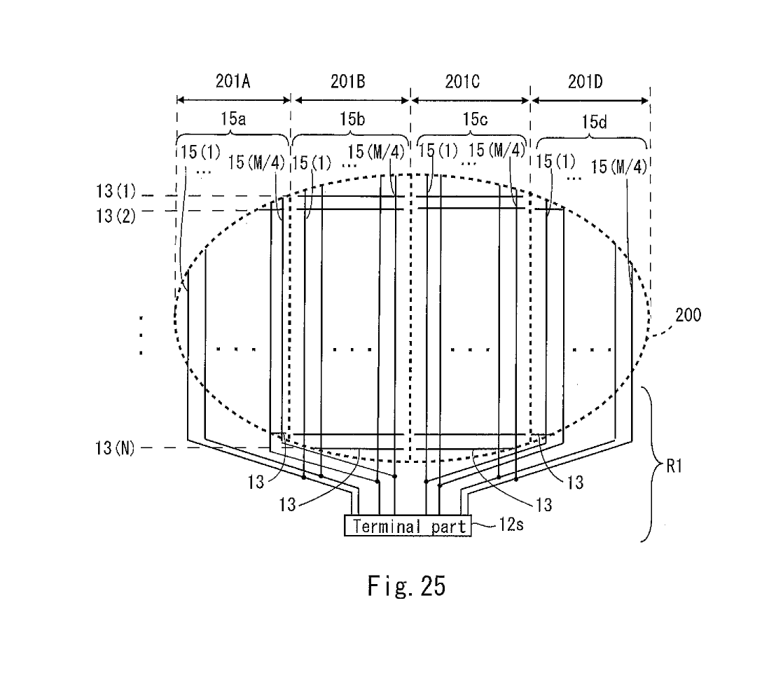

For example, as illustrated in FIG. 25, the active matrix substrate 20a may have a display region 200 in a circular shape composed of pixel groups formed in areas 201A to 201D in non-rectangular shapes. In each of the areas 201A to 201D, a plurality of gate lines 13 and a plurality of source lines 15 are arranged.

Though illustration is omitted in FIG. 25, gate drivers 11 for driving the gate lines 13 in each area are arranged in each area, as is the case with Embodiments 1 to 7 described above. In the example illustrated in FIG. 25, however, the columns do not have uniform numbers of pixels in each area, and therefore, the lengths of the gate lines 13 are not uniform. In this case, the gate driver 11 is provided to the gate line 13 provided in the column having the largest number of pixels among the columns in each area.

Further, as illustrated in FIG. 25, the terminal part 12s for supplying data signals to the source lines 15 in each area is arranged in the frame region R1. As is the case with Embodiment 2 described above, the source lines 15 in the area 201A and those in the area 201D are routed form the terminal part 12s so as to be approximately horizontally symmetric with respect to the boundary between the area 201B and the area 201C interposed therebetween. In the frame region R1, the source lines 15b and 15c in the areas 201B and 201C are connected to the source line portions 150a and 150d in the frame region R1.

In the present embodiment as well, as is the case with Embodiment 2, the number of source lines routed in the frame region R1 is only M/4, and this allows the frame region R1 to have a smaller width L as compared with the case of Embodiment 1. Further, by arranging the gate driver 11 in each area, not only the frame region R1 but also frame regions in outer edge portions of the display region 200 can be narrowed, which makes it possible to produce a display panel in a non-rectangular shape.

The embodiments of the present invention, described above, are merely examples for implementing the present invention. The present invention, therefore, is not limited to the above-described embodiments, and any of the above-described embodiments can be modified appropriately without departing from the scope of the invention so that the present invention is implemented. The following description describes modifications of the present invention.

### <Modification>

(1) In Embodiments 1 to 8, the source lines 15 in one of adjacent areas are routed from the terminal part 12s, and the source lines 15 in the other area are connected to the source lines 15 in the one area in the frame region R1 where the terminal part 12s is provided. The connection, however, may be as follows.

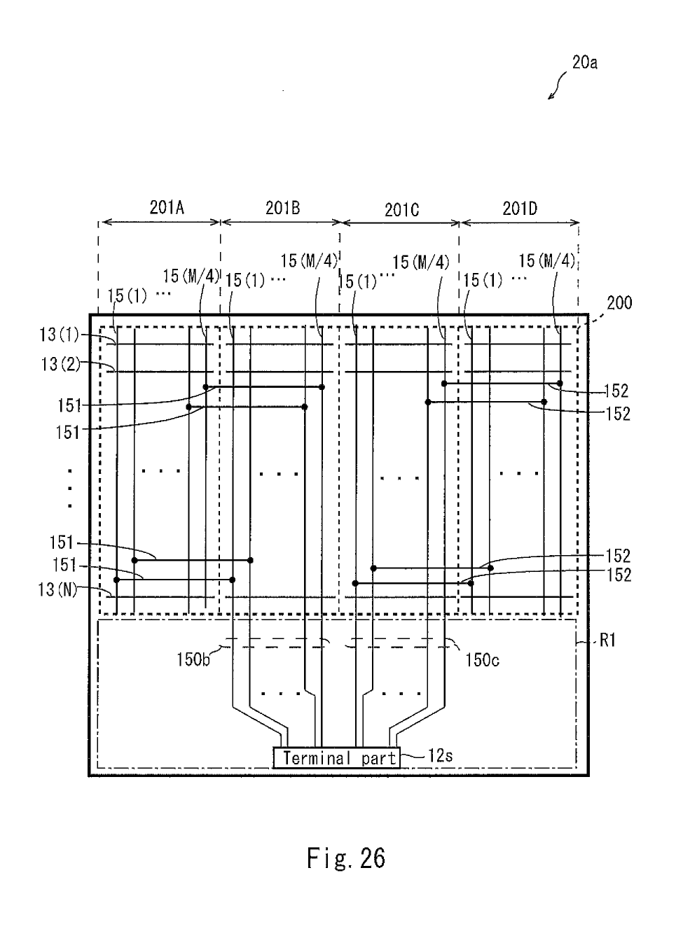

FIG. 26 is a schematic diagram illustrating an exemplary connection of source lines on an active matrix substrate in a modification example of the present invention. As is the case with Embodiment 2, independent gate lines 13(1) to 13(N) are formed in the areas 201A to 201D.

As illustrated in FIG. 26, in the present modification example, source lines 15b and 15c are respectively routed from the terminal part 12s to the area 201B and the area 201C. In the area 201A and the area 201D, source lines 15a and 15d that intersect with all of the gate lines 13 (13(1) to 13(N)) (for example, see FIG. 10) provided in the foregoing areas are provided. In the area 201A and the area 201B, connection lines 151 each of which connects one source line 15a and one source line 15b corresponding to the source line 15a are provided. Further, in the area 201C and the area 201D, connection lines 152 each of which connects one source line 15c and one source line 15d corresponding to the source line 15c are provided. The connection lines 151 and 152 are formed in the same layer as the gate lines 13.

Since the source lines 15a in the area 201A are connected through the connection lines 151 with the source lines 15b in the area 201B, respectively, data signals for the area 201A supplied from the terminal part 12s can be received through the source lines 15b and the connection lines 151. Further, since the source lines 15d in the area 201D are connected through the connection lines 152 with the source lines 15c in the area 201C, respectively, data signals from the terminal part 12s for the area 201D can be received through the source lines 15c and the connection lines 152.

In this example, the gate lines 13 in the area 201B and the area 201C are driven by the gate drivers 11 in the area 201B and the area 201C, so that data signals are written in the area 201B and the area 201C. During this period, the gate lines 13 in the area 201A and the area 201D are not driven. By so doing, data signals of the area 201B and the area 201C are input to the source lines 15a and 15d in the area 201A and the area 201D through the connection lines 151 and 152, but the data signals are not written in the area 201A and the area 201D.

Further, after data signals are written in the area 201B and the area 201C, the gate lines 13 in the area 201A and the area 201D are driven by the gate drivers 11 in the area 201A and the area 201D, whereby data signals are written in the area 201A and the area 201D. During this period, the gate lines 13 in the area 201B and the area 201C are not driven. This allows data signals in the area 201A and the area 201D to be input to the source lines 15b, 15c in the area 201B and the area 201C, but the data signals are not written in the area 201B and the area 201C.

The parts of the source lines 15b and 15c arranged in the frame region R1 may be arranged alternately in the first metal layer 1300 and the second metal layer 1500, as is the case with Embodiment 5 described above. With such a configuration, the frame region R1 can have a further smaller width L1.

(2) In Embodiments 1, 3, 6, 7, and 8 described above, the source line portions in one area arranged in the frame region R1, and the source lines in another area adjacent to the foregoing one area, may be connected by using the connection lines 131, as is the case with Embodiment 2. The source line portions in one area arranged in the frame region R1 may be formed alternately in the first metal layer 1300 and the second metal layer 1500, and may be connected with the source lines in another area by using the connection lines 161 formed in the third metal layer 1600, as is the case with Embodiment 5.

(3) Embodiments 1 to 8 described above are described with reference to an example in which the source lines 15 in one area connected with the terminal part 12s are connected with the source lines 15 in one area adjacent to the foregoing one area, but the configuration may be as follows. For example, in a case where a display region 200 composed of three areas having independent pixel groups, respectively, is provided on the active matrix substrate 20a, the source lines 15 in one area connected to the terminal part 12s may be connected with the source lines 15 in the two other areas. In this case, the following control is performed: the gate lines 13 are driven area by area according to a preliminarily determined order in which the gate lines of the three areas are driven, and data signals to be written in the area are supplied thereto.

### DESCRIPTION OF REFERENCE NUMERALS

1 . . . liquid crystal display device
1, 2 . . . display panel
3 . . . source driver
4 . . . display control circuit
5 . . . power source 5
11, 110 . . . gate driver
12g, 12s . . . terminal part
13 . . . gate line
15 . . . source line
16 . . . control line
20a . . . active matrix substrate
20b . . . counter substrate
131, 151, 152, 161 . . . connection line
150, 150a to 150d . . . source line portions
200 . . . display region
201A to 201D . . . area
1300 . . . first metal layer
1500 . . . second metal layer
1600 . . . third metal layer
R1 to R4 . . . frame region
SW1, SW2 . . . switching element

1. An active matrix substrate comprising:
a display region in which a plurality of pixel regions each of which includes data lines and gate lines are arrayed along a direction in which the gate lines extend;
a terminal part provided outside the display region, in a first frame region in vicinity of one-side ends of the data lines, the terminal part supplying a data signal; and
driving circuits provided in each of the pixel regions, for switching the gate lines in the pixel regions to a selected state or a non-selected state,
wherein the data lines in at least one pixel region among the plurality of pixel regions are connected with the terminal part, and the data lines in another pixel region are connected with the data lines in the one pixel region.

2. The active matrix substrate according to claim 1,
wherein the data lines in the one pixel region and the data lines in the another pixel region are connected with each other in the first frame region.

3. The active matrix substrate according to claim 2, further comprising:
a switching part that selectively switches the data lines in the one pixel region for inputting the data signal, among the data lines in the one pixel region and the another pixel region.

4. The active matrix substrate according to claim 2,
wherein the active matrix substrate has a laminate structure that includes a first metal layer, and a second metal layer that is different from the first metal layer,
the gate lines are formed in the first metal layer, and
the data lines are formed in the second metal layer,
the active matrix substrate further comprising connection lines formed in the first metal layer or the second metal layer, the connection lines connecting, among the data lines of the another pixel region, the data lines that when extended intersect with the data lines of the one pixel region in the first frame region, and the data lines of the one pixel region.

5. The active matrix substrate according to claim 2,
wherein the active matrix substrate has a laminate structure that includes a first metal layer, and a second metal layer that is different from the first metal layer,
the gate lines are formed in the first metal layer,
the data lines in the another pixel region are formed in the second metal layer, and
the data lines in the one pixel region have portions arranged in the one pixel region, which are formed in the second metal layer, and portions arranged in the first frame region, which are formed in the first metal layer,
the active matrix substrate further comprising connection lines formed in the second metal layer, the connection lines connecting the data lines in the another pixel region and the data lines in the one pixel region.

6. The active matrix substrate according to claim 2,
wherein the active matrix substrate has a laminate structure that includes a first metal layer, a second metal layer that is different from the first metal layer, and a third metal layer that is different from the first and second metal layers,
the gate lines are formed in the first metal layer,
the data lines in the another pixel region are formed in the second metal layer, and
the data lines in the one pixel region have portions arranged in the one pixel region, which are formed in the second metal layer, and portions arranged in the first frame region, which are formed in the first metal layer or the second metal layer,
the active matrix substrate further comprising connection lines formed in the third metal layer, the connection lines connecting the data lines in the one pixel region and the data lines in the another pixel region.

7. The active matrix substrate according to claim 1,
wherein the data lines in the another pixel region are formed with the data lines in the one pixel region that are extended to the another pixel region while passing through a second frame region that is on an opposite side to the first frame region.

8. The active matrix substrate according to claim 1,
wherein the data lines of the one pixel region and the data lines of the another pixel region are connected with each other in the display region.

9. The active matrix substrate according to claim 1,
wherein a frame frequency for writing the data signal to a part of pixels in at least one pixel region among the pixel regions is lower than a frame frequency for writing the data signal to other pixels in the pixel region.

10. The active matrix substrate according to claim 1,
wherein the display region has a non-rectangular shape.

11. A display device comprising:
the active matrix substrate according to claim 1; and
a counter substrate including color filters provided at positions respectively corresponding to the pixels on the active matrix substrate.

12. The display device according to claim 11,
wherein the color filters include color filters of R (red), G (green), and B (blue), and
the color filters of R (red), G (green), and B (blue) are arrayed in an order of R (red), G (green), and B (blue) along a direction in which the data lines extend on the active matrix substrate.
